(19) United States
(12) Patent Application Publication
(10) Pub. No.: US 2025/0335214 A1
(43) Pub. Date: Oct. 30, 2025

(54) DYNAMIC WORKSPACE CREATION WITH AUTOMATED OBFUSCATION AS A COMPUTING SERVICE

(71) Applicant: International Business Machines Corporation, Armonk, NY (US)

(72) Inventors: Bo Wen, Chappaqua, NY (US); Jeffrey L. Rogers, Briarcliff Manor, NY (US); John Paul De Marco, Brighton, MI (US); Richard Anthony Hennessy, Austin, TX (US)

(21) Appl. No.: 18/647,672

(22) Filed: Apr. 26, 2024

(51) Int. Cl. G06F 9/451; G06F 21/60; G06F 21/62

(52) U.S. Cl. CPC G06F 9/451; G06F 21/604; G06F 21/6254

(57) ABSTRACT

Mechanisms are provided for dynamically generating workspaces and provisioning them with datasets. The mechanisms store datasets in a data vault for provisioning to dynamically generated workspaces associated with users. The dynamically generated workspaces are computer environments through which the users can perform operations on the one or more datasets. The mechanisms receive a request, from a user, for access to a specified dataset, and retrieve a data usage agreement (DUA) corresponding to a pairing of the user with the specified dataset. The DUA specifies a level of obfuscation to be applied to the specified dataset when provisioning a workspace associated with the user, with the specified dataset. The mechanisms dynamically generate, on-demand, the workspace associated with the user based on the retrieved DUA. The mechanisms also automatically provision, on-demand, the dynamically generated workspace with a version of the specified dataset corresponding to the level of obfuscation specified in the DUA.

### BACKGROUND

The present application relates generally to an improved data processing apparatus and method and more specifically to an improved computing tool and improved computing tool operations/functionality for providing dynamic workspace creation with automated obfuscation as a computing service.

Data usage agreements are agreements that govern the sharing of data between collaborators. These data usage agreements generally describe what data is being shared, for what purpose, and for how long, as well as other access restrictions or security protocols that must be followed by the recipient of the data. While data usage agreements may be feasible on an individual one-on-one user-software basis, it is not feasible for individuals in large organizations, which may license and utilize hundreds of different software resources, to remember to use which software for which scenarios for hundreds of different use cases.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer-implemented method for dynamically generating workspaces and provisioning them with datasets is provided. The method comprises storing a plurality of datasets in a data vault for provisioning to dynamically generated workspaces associated with users. The dynamically generated workspaces are computer environments through which the users can perform operations on the one or more datasets. The method further comprises receiving a request, from a user, for access to a specified dataset, and retrieving a data usage agreement (DUA) corresponding to a pairing of the user with the specified dataset. The DUA specifies a level of obfuscation to be applied to the specified dataset when provisioning a workspace associated with the user, with the specified dataset. The method also comprises dynamically generating, on-demand, the workspace associated with the user based on the retrieved DUA. Moreover, the method comprises automatically provisioning, on-demand, the dynamically generated workspace with a version of the specified dataset corresponding to the level of obfuscation specified in the DUA.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1A is an example diagram illustrating a three dimensional space for representing a project in accordance with one illustrative embodiment;

FIG. 1B is an example diagram illustrating the relationship between components of an Obfuscation-as-a-Service (OaaS) platform and the corresponding smart filtering in accordance with one illustrative embodiment;

FIG. 2 is an example block diagram of the primary operational components of an Obfuscation-as-a-Service (OaaS) platform in accordance with one illustrative embodiment;

FIG. 3 is an example diagram illustrating the relationships between Data Usage Agreements (DUAs), users, and datasets within the Obfuscation-as-a-Service (OaaS) platform 200, in accordance with one illustrative embodiment;

FIG. 4 is an example user experience lifecycle diagram illustrating an example process for processing intake forms and/or requesting access to datasets in accordance with one illustrative embodiment;

FIG. 5 is an example diagram illustrating an example process for a data intake operation in accordance with one illustrative embodiment;

FIGS. 6A-6D set forth an example flowchart outlining a data request decision making process in accordance with one illustrative embodiment;

FIG. 7 is an example flowchart outlining an example data provisioning lifecycle process in accordance with one illustrative embodiment;

FIG. 8 depicts a cloud computing environment according to an embodiment of the present invention;

FIG. 9 depicts abstraction model layers according to an embodiment of the present invention; and

FIG. 10 is an example diagram of a computing system in which aspects of the illustrative embodiments may be implemented in accordance with one illustrative embodiment.

### DETAILED DESCRIPTION

The illustrative embodiments provide an improved computing tool and improved computing tool operations/functionality for providing an Obfuscation-as-a-Service (OaaS) platform that provides capabilities to land datasets, models, and the like, integrate (associate) the datasets, models, etc. into a data vault, and then tokenize subsets of the data vault datasets, models, etc. for provisioning into workspaces to support various initiatives or studies at scale. While the illustrative embodiments will be described hereafter in terms of operations and infrastructure to support research endeavors, and specifically medical research endeavors in which datasets may specify personally identifiable information (PII)/personal health information (PHI) for one or more patients, it should be appreciated that the present invention is not limited to such. Rather, the illustrative embodiments may be implemented to support any artificial intelligence based system and endeavor in which obfuscation of the underlying data is an important feature to maintain for privacy and/or security concerns.

For example, some embodiments of the present invention may be implemented with regard to financial domains, e.g., banking and investment datasets, models, etc., retail/electronic commerce domains, education domains, social networking domains, human resources domains, government domains, or the like. With the retail/electronic commerce domains, as an example, the mechanisms of the illustrative embodiments may operate to safeguard customers' personal data including purchase history, payment details, personal preferences etc., while still enabling data scientists/analysts or automated computing systems to derive valuable insights based on other retail data. With regard to the education domain, with a vast amount of personal information being stored, educational institutions may benefit from the mechanisms of the illustrative embodiments to protect students' and staffs' personal data, such as grades, medical conditions, or financial situation, while allowing analytics to be executed on evaluating the educational institution's educational performance.

With a social networking domain, social media companies collect substantial user data not limited to personal preferences and behavior patterns. To ensure privacy and avoid potential misuse of the data, the illustrative embodiments may be utilized to obfuscate data. In the human resources domain, the mechanisms of the illustrative embodiments can be used to obfuscate sensitive information, such as employees' personal details, salary, evaluation results, and other confidential information, but allowing analysis on overall company operational efficiency. In the government domain, government agencies hold a significant amount of personal data about citizens which can be vital for decision and policy making. The illustrative embodiments may be implemented to provide the necessary privacy measures while retaining the usefulness of the data. For purposes of illustration only, and to facilitate understanding of the following description of example illustrative embodiments, the following description will assume a medical or health related domain with datasets comprising data for one or more patients.

It should also be appreciated that the following description may make reference to various terms that are specific to the GitLab™ technology (GitLab™ is a trademark of GitLab Inc. in the United States and other countries and regions) as examples of one way to implement aspects of the invention. Thus, reference may be made to terms such as “repo”, “branch”, “fork”, “commit”, and the like, which are intended to reference these concepts as they are understood within the GitLab™ technology. The GitLab technology provides a web based platform that helps developers collaborate on large and complex projects using Git, a distributed version control system that tracks changes in any set of computer files. It should be appreciated that GitLab™ is used only as an example in this description, and other software development and information technology operations (DevOps) technologies providing similar functionalities may be used without departing from the spirit and scope of the present invention.

The OaaS platform of the illustrative embodiments provides functionality and infrastructure that facilitates the storage and maintaining of datasets, models, and the like, in a data vault with data usage agreements (DUAs) and role-based access control mechanisms that control how these stored and maintained datasets, models, and the like may be provisioned to dynamically created workspace environments. As part of this, role-based access controls, which may be embodied in the rules and data structures of the DUAs, and corresponding obfuscation of personally identifiable information (PII) and/or personal health information (PHI) are implemented with a corresponding DUA governing the actions that can be performed with regard to the dataset in the dynamically created workspace environment. Based on the correlation of the user identifier, user role, and DUAs (and role-based access controls (RBACs) represented in these DUAs), as well as dataset information, obfuscation of PII/PHI is automatically handled when creating and provisioning dynamic workspace environments in an on-demand manner.

Thus, the OaaS platform provides an architecture to automatically handle the creation of analytic workspaces in a dynamic manner with automated handling of DUAs and RBACs with regard to these analytic workspaces such that access by users to datasets is automatically controlled based on the particular pairings of users and datasets. These analytic workspaces are the compute environments that users (e.g., researchers) need to complete their work based on particular datasets obtained from the data vault. These analytic workspaces may be, but are not limited to, cloud virtual machines, integrated development computer environments for developing software and artificial intelligence models, such as IBM Watson® Studio workspaces, air-gapped bare-metal machines within isolated network environments, desktop instances, or the like, and comprise the computer hardware and/or software necessary to perform analytic operations on datasets.

Workspaces for users may be generated with controls on data access through data usage agreements, however controlling data access based on only data usage agreements (DUAs) does not take into consideration the level of data obfuscation required for different users or different datasets. Furthermore, there may not be a correlation between data obfuscation with the data usage agreements, which limits the ability to dynamically provision workspaces with specific obfuscated datasets. The illustrative embodiments provide an improved computing tool and improved computing tool operations/functionality that associates the level of data obfuscation with the data usage agreement and tailors how data is presented in analytic workspaces based on an automatically determined dataset-user pairing. This allows for a user-specific and data-specific approach to analytic workspace provisioning of datasets and maintains better control over the security and privacy of the datasets. The illustrative embodiments dynamically generate analytic workspaces based on this combined paired information rather than relying on static DUAs.

Furthermore the illustrative embodiments provide a flexible data obfuscation computing tool and computing tool operations/functionality that takes into account the nature of the data in the datasets and prior dataset access approvals/denials. The illustrative embodiments provide mechanisms for adapting datasets to a range of possible levels of security and data obfuscation, such as security ranging from completely personal health information/personally identifiable information (PHI/PII)-free, to limited PHI/PII exposure or customized obfuscation, which dramatically improves the usability and flexibility of the analytic workspaces. The illustrative embodiments provide the ability to manage and classify diverse multi-modal datasets with extended metadata based on field specific taxonomies.

The improved computing tool and improved computing tool operations/functionality of the illustrative embodiments provide an integration of data usage agreements, obfuscation, workspace generation, and automatic dataset provisioning which addresses a problem that arises in the computer arts with regard to analytic workspace access to datasets potentially having sensitive information therein. That is, the improved computing tools and improved computing tool operations/functionality are an improvement over existing computing systems in that the illustrative embodiments provide a solution that implements a time efficient, secure, and customized creation of analytic workspaces based on the user's access level and data requirements while maintaining the security requirements of the datasets being accessed, through automated obfuscation of the datasets either when ingested into the data vault and/or when provisioning the datasets to the dynamically generated analytic workspaces.

The following description provides examples of embodiments of the present disclosure, and variations and substitutions may be made in other embodiments. Several examples will now be provided to further clarify various aspects of the present disclosure.

Example 1: a computer-implemented method for dynamically generating workspaces and provisioning them with datasets is provided. The method comprises storing a plurality of datasets in a data vault for provisioning to dynamically generated workspaces associated with users. The dynamically generated workspaces are computer environments through which the users can perform operations on the one or more datasets. The method further comprises receiving a request, from a user, for access to a specified dataset, and retrieving a data usage agreement (DUA) corresponding to a pairing of the user with the specified dataset. The DUA specifies a level of obfuscation to be applied to the specified dataset when provisioning a workspace associated with the user, with the specified dataset. The method also comprises dynamically generating, on-demand, the workspace associated with the user based on the retrieved DUA. Moreover, the method comprises automatically provisioning, on-demand, the dynamically generated workspace with a version of the specified dataset corresponding to the level of obfuscation specified in the DUA.

The above limitations advantageously enable dynamic on-demand creation of analytic workspaces for users to perform operations on datasets. The above limitations further advantageously enable the dynamic and automated application of data usage agreements (DUAs) and associated role-based access controls (RBACs) to the datasets when provisioning them to the dynamically generated analytic workspaces. In accordance with these automatically applied DUAs and RBACs, an appropriate version of the dataset may be provisioned or published to the workspace which has the appropriate obfuscation/masking of portions of the dataset in accordance with the DUA and RBACs associated with the particular pairing of user and dataset.

Example 2: The limitations of any of Examples 1 and 3-10, where automatically provisioning, on-demand, the dynamically generated workspace comprises selecting a version of the specified dataset that has the level of obfuscation specified in the DUA from a plurality of versions of the specified dataset stored in the data vault. The above limitations advantageously enable dynamic on-demand creation of analytic workspaces for users to perform operations on datasets where the security of information in the provisioned datasets is maintained through adaptive obfuscations based on DUAs.

Example 3: The limitations of any of Examples 1-2 and 4-10, where the dynamically generated workspace is one of a cloud virtual machine, an integrated development computer environment, or a computer desktop instance. The above limitations advantageously enable dynamic on-demand creation of analytic workspaces for users to perform operations on datasets in various types of data processing environments.

Example 4: The limitations of any of Examples 1-3 and 5-10, further comprising automatically determining whether to approve or deny the request based on a generated representation of the request in a multi-dimensional project space representing at least a pairing of the user and the specified dataset, and comparing the representation of the request to representations of previous requests. The above limitations advantageously enable dynamic on-demand creation of analytic workspaces for users to perform operations on datasets in which prior approvals/denials in similar situations represented in a multi-dimensional project space may be leveraged to determine whether to approve or deny a current request.

Example 5: The limitations of any of Examples 1-4 and 6-10, where the multi-dimensional project space is a three dimensional project space having a user profile dimension, a dataset dimension, and a compute environment dimension, where the user profile dimension comprises one or more characteristics of the user from which the request is received, the dataset dimension comprises one or more characteristics representing at least a security level required for accessing a corresponding dataset, and the compute environment dimension comprises one or more characteristics representing a level of security afforded by a corresponding compute environment. The above limitations advantageously enable dynamic on-demand creation of analytic workspaces for users to perform operations on datasets using a three dimensional project space representation of the request to evaluate multiple characteristics of the request relative to other requests and the resulting approvals/denials in these other requests.

Example 6: The limitations of any of Examples 1-5 and 7-10, where automatically determining whether to approve or deny the request comprises: comparing a first point in the multi-dimensional project space corresponding to the request, to a plurality of second points corresponding to other requests with which an approval or denial has been previously associated; and automatically determining whether to approve or deny the request based on results of the comparison, where the dynamically generating and automatically provisioning operations are performed in response to approval of the request. The above limitations advantageously enable dynamic on-demand creation of analytic workspaces for users to perform operations on datasets in which similarity metrics between points in a multi-dimensional project space may be used as a basis for determining prior approvals/denials that may be reused to determine whether to approve/deny the current request.

Example 7: The limitations of any of Examples 1-6 and 8-10, where comparing the first point to the plurality of second points comprises determining whether the first point falls within a safe range of the plurality of second points, falls within a decline range of the plurality of second points, or falls within a boundary edge case range of the plurality of second points. The above limitations advantageously enable dynamic on-demand creation of analytic workspaces for users to perform operations on datasets in which regions of requests that can be safely approved, regions of request that should definitely be denied, and regions where it is unclear whether the requests should be approved/denied, may be specified and a determination of whether to approve/deny the current request, or perform additional evaluation of the request, may be determined from plotting a point corresponding to the current request in the multi-dimensional project space and determining which region the point falls into. This provides an automated approval/denial process for a large number of requests based on such a plotting of the point corresponding to the request.

Example 8: The limitations of any of Examples 1-7 and 9-10, where in response to the first point falling within the safe range, the request is automatically approved, where in response to the first point falling within the decline range, the response is automatically denied, and where in response to the first point falling within a boundary edge case range, the request is escalated for human review and approval. The above limitations advantageously enable dynamic on-demand creation of analytic workspaces for users to perform operations on datasets in which the plotting of the point corresponding to the current request may be used along with the defined ranges to determine an automatic approval/denial, or escalation of the request.

Example 9: The limitations of any of Examples 1-8 and 10, where dynamically generating, on-demand, the workspace associated with the user based on the retrieved DUA comprises automatically adjusting a security level of the compute environment of the workspace to match a required security level for the DUA. The above limitations advantageously enable dynamic on-demand creation of analytic workspaces for users to perform operations on datasets in which the security of the workspace may be automatically adjusted so as to provide the required level of security as specified in a DUA. This maintains the security of the datasets worked on within the workspace.

Example 10: The limitations of any of Examples 1-9, where the plurality of versions of the specified dataset comprise a first version of the specified dataset in which all personal health information or personally identifiable information is obfuscated, a second version of the specified dataset in which some, but not all, personal health information or personally identifiable information is obfuscated, and a third version of the specified dataset in which none of the personal health information or personally identifiable information is obfuscated. The above limitations advantageously enable dynamic on-demand creation of analytic workspaces for users to perform operations on datasets in which various versions of a dataset may be generated and stored for quickly provisioning datasets to workspaces based on DUAs and security level requirements of the datasets. That is, a corresponding level of obfuscation for the required security level may be determined and the corresponding version of the dataset identified and automatically provisioned to the workspace in a quick and timely manner.

Example 11: A system comprising one or more processors and one or more computer-readable storage media collectively storing program instructions which, when executed by the one or more processors, are configured to cause the one or more processors to perform a method according to any one of Examples 1-10. The above limitations advantageously enable a system comprising one or more processors to perform and realize the advantages described with respect to Examples 1-10.

Example 12: A computer program product comprising one or more computer readable storage media, and program instructions collectively stored on the one or more computer readable storage media, the program instructions comprising instructions configured to cause one or more processors to perform a method according to any one of Examples 1-10. The above limitations advantageously enable a computer program product having program instructions configured to cause one or more processors to perform and realize the advantages described with respect to Examples 1-10.

In some illustrative embodiments, a method, apparatus, and computer program product are provided which implement operations and functionality of a computer readable program provided on a computer useable or readable medium which, when executed, causes a data processing system, processor, or computing device to perform various ones of, and combinations of, the operations outlined above with regard to one or more of Examples 1-10. Moreover, the computer readable program may cause the data processing system, processor, or computing device to dynamically generate computer programs configured to: intake datasets to the data vault; catalog the intake datasets; perform patient association; associate and apply appropriate security settings for the study intake datasets to govern data vault access, dataset retention, and other operations; dynamically provision workspaces; publish data from the data vault to workspaces while applying appropriate obfuscation or tokenization methods; send user notifications; monitor access to the environment; and dynamically publish approved workspace datasets, models, and publications to a marketplace for consumption by third parties.

As mentioned above, the Obfuscation-as-a-Service (OaaS) platform of the illustrative embodiments provides functionality and infrastructure that facilitates the storage and maintaining of datasets, models, and the like, in a data vault with data usage agreements (DUAs) and role-based access control mechanisms that control how these stored and maintained datasets, models, and the like may be provisioned to dynamically created workspace environments. In some of the illustrative embodiments, the OaaS platform operates based on the notion that projects, operated on by users via analytic workspaces, may be represented as having three primary dimensions: dataset, data user profile, and compute environment. Based on this three dimensional representation of projects, a request by a user for access to a dataset via an analytic workspace is a point in this three dimensional space.

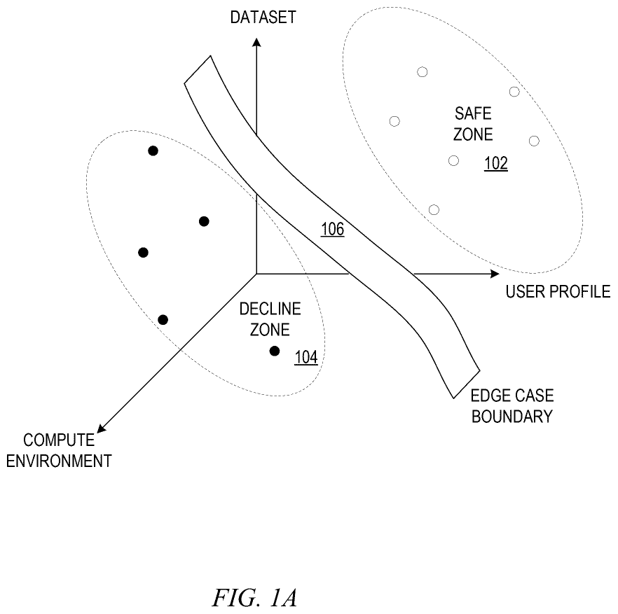

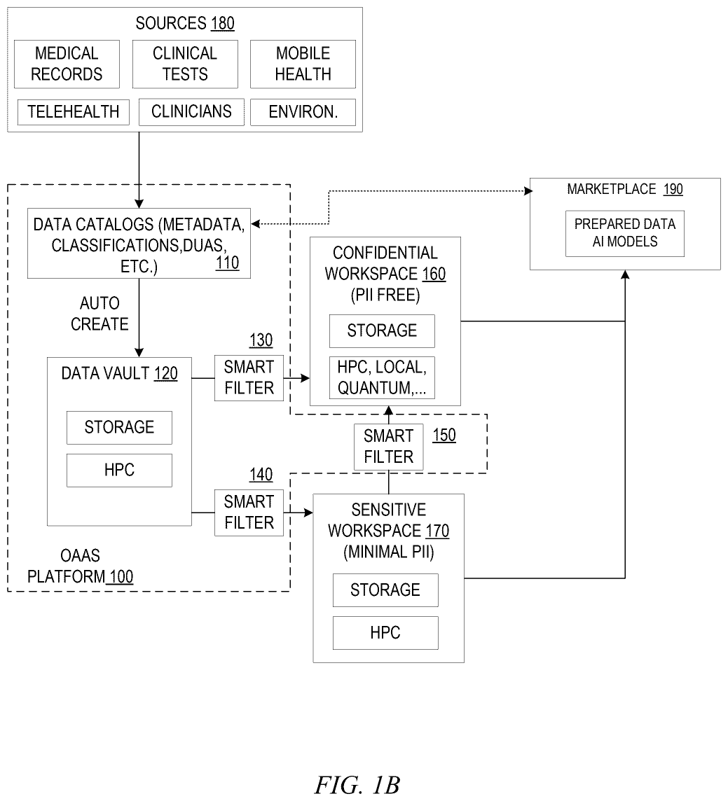

For example, FIG. 1A illustrates an example of a three dimensional project space having these three dimensions. Points in this project space may represent a project with regard to these three dimensions, where each of the three dimensions may have one or more corresponding factors that determine the particular dimension. Thus, the projects are represented by multidimensional points in the project space.

As shown in FIG. 1A, by correctly defining these three dimensions in the representation of projects, the points (representing the projects) can be separated into two clusters: those that are a “low risk” zone where requests for access to the datasets of those projects can be approved automatically with high confidence (safe zone 102), and those that are “high risk” where dataset access requests should be declined (decline zone 104). This reduces the workload of review to defining the boundary interface between these two zones, i.e., the edge cases falling within the edge case boundary interface 106, where dataset access control rules are not yet clear.

The safe zone 102 is a region that contains the approved edge cases, which are previously reviewed and approved data access requests that serve as reference points for automatically approving similar requests. If a new request falls within the safe zone 102, it is likely to be automatically approved. The decline zone 104 is a region that contains the denied edge cases, which are previously reviewed and denied data access requests. If a new request falls within the decline zone, or below the decline line, it is likely to be automatically denied unless adjustments can be made to meet the dataset's security requirements.

The edge case boundary region 106 represents the demarcation between the safe zone 102 and the decline zone 104. Requests falling near this boundary 106 require closer evaluation and may need adjustments to the user profile, compute environment security settings, or PHI/PII obfuscation or masking performed to meet the dataset's security requirements. If the necessary adjustments are unclear or insufficient, the request is escalated for human review.

By comparing the dimensions associated with a request for access to a dataset to the dimensions of previous request, the OaaS platform may cluster the new request with subsets of the previous request which may fall into one of the defined zones 102-106. That is, a new request will be a request from a particular user, from which a user profile dimension may be determined, will specify a particular dataset of interest from which a dataset dimension may be determined, and will be from a computing system or requesting a computing system having a particular compute environment from which the compute environment dimension may be determined. This information may be used to plot a point in the project space and permit a clustering or similarity analysis to be executed on the new point with regard to other points already plotted, i.e., previously processed requests or an initial set of project approval/denial decisions prepopulated into the system. Based on this analysis, the new request may be determined to be within one of the safe, declined, or edge case boundary regions 102-106. Based on the region classification, the request may be automatically approved, denied, or directed to appropriate mechanisms or personnel for further evaluation and determination of whether to approve or deny the request.

It should be noted that this three dimensional space, and its associated edge case boundary interface 106 are different for each engagement between parties governed by data usage agreements. For example, the data usage agreement (DUA) between a first party and a second party may be different from the data usage agreement between a third party and the second party. Moreover, the DUA may be different for the same two parties, e.g., first party and second party, depending on the particular regulations governing the engagement, e.g., the DUA between the parties with regard to the United States of America may be governed by Health Insurance Portability Action (HIPPA), whereas in the European Union the engagement may be governed by General Data Protection Regulation (GDPR). Thus, for each DUA, at the beginning of the collaboration/engagement, there may be some initial agreement to resolving some of the “edge cases”. However, as time goes by, the mechanisms of the illustrative embodiments may leverage this initial configuration and subsequent approvals/denials of edge cases to increasingly be able to auto-approve more and more dataset access requests based on the accumulated results. That is, as approvals/denials are determined by the OaaS platform, either automatically, or semi-automatically with human review, these subsequent decisions may be added to the stored data regarding approvals/denials which may then be used to update the various zones 102-106 and process subsequent requests.

As noted above, in some illustrative embodiments, the three-dimensional space for representing a project comprises the dataset dimension, user profile dimension, and compute environment dimension. This is only an example, and other dimensions may be used in addition to, or in replacement of, these specific dimensions depending on the desired implementation. In further embodiments, the dimensional space may be expanded to capture artificial intelligence (AI) compliance requirements, such as those outlined in the NIST AI Risk Management Framework, EU AI Act, US AI Executive Order, CCPA, NY AI Framework, and other regulatory guidelines. This could facilitate proactive automated access policy enforcement, dynamic data tokenization for privacy, continuous monitoring of data usage, defining security postures for varying sensitivity levels and risk profiles, and ensuring compliance via policy enforcement at the attribute level. Assuming the three dimensions of dataset, user profile, and compute environment, the following provides more detailed explanations of each dimension.

With regard to the dataset dimension, this dimension may involve various aspects or characteristics of the dataset, which in some illustrative embodiments includes, but is not limited to, one or more of PHI/PII Classification, Data Source and Provenance, Data Quality Metrics, Data Usage Restrictions, Data Subject Demographics, Data Collection Methods, and Data Update Frequency and Version Control. These aspects/characteristics are further described as follows: PHI/PII Classification: Datasets are classified based on the level of Protected Health Information (PHI) or Personally Identifiable Information (PII) they contain, such as “Full PHI/PII,” “Partial PHI/PII,” or “No PHI/PII”. This classification allows the OaaS platform of the illustrative embodiments to determine the level of scrutiny required for each dataset and facilitates the identification of previously approved datasets with matching PHI/PII levels.
Data Source and Provenance: Information about the origin of the dataset, such as the specific institution, department, or system the dataset was collected from, is included to help assess the reliability and trustworthiness of the data.
Data Quality Metrics: Measures of data completeness, accuracy, consistency, and timeliness are incorporated to assist in determining the suitability of the dataset for specific research purposes.
Data Usage Restrictions: Any contractual, legal, or ethical constraints on how the data can be used, such as limitations on commercial use, data sharing, or publication of results, are specified. Time limits on the data usage and requirements on how to dispose of the data at the end of the usage lifecycle (delete, return, etc.) may be specified.
Data Subject Demographics: Demographic information about the individuals represented in the dataset, such as age, gender, race, and geographic location, is included to help ensure diversity and representativeness in research studies.
Data Collection Methods: The procedures and instruments used to collect the data, such as surveys, medical devices, or electronic health record systems, are described to help assess the reliability and validity of the data.
Data Update Frequency and Version Control: The frequency of dataset updates and the implementation of versioning are indicated to ensure that researchers are using the most appropriate and up-to-date version for their analysis.

With regard to the user (e.g., researcher) profile dimension, this dimension may involve various aspects or characteristics of the user profiles, which in some illustrative embodiments includes, but is not limited to, one or more of Institutional Affiliation, Track Record, Conflict of Interest Disclosures, Data Security and Privacy Training, Collaborator and Team Member Information, Institutional Review Board (IRB) Approval, and Data Use Agreement (DUA) Acceptance. Assuming the user to be a human researcher, these aspects/characteristics are further described as follows:
Institutional Affiliation: Information about the researcher's primary institution, department, and position is included to verify their credentials and assess their level of expertise.
Research Track Record: Metrics on the researcher's past publications, grants, and collaborations in relevant fields are incorporated to demonstrate their experience and competence in handling sensitive data.
Conflict of Interest Disclosures: Researchers are required to declare any potential conflicts of interest, such as financial interests or personal relationships, that may bias their use of the data.
Data Security and Privacy Training: The completion of specific training courses or certifications related to data security, privacy, and ethical research practices is specified.
Collaborator and Team Member Information: Details about other individuals who may have access to the data through their collaboration with the primary researcher are included, ensuring that all team members meet the necessary qualifications and training requirements.
Institutional Review Board (IRB) Approval: Documentation of IRB approval for the proposed research project is provided, demonstrating compliance with ethical guidelines and oversight.
Data Use Agreement (DUA) Acceptance: The researcher's acceptance of the specific terms and conditions outlined in the DUA for the requested dataset is tracked.

With regard to the compute environment dimension, this dimension may involve various aspects or characteristics of the compute environment, which in some illustrative embodiments includes, but is not limited to, one or more of Security Features and Controls, Network Security Controls, Data Backup and Disaster Recovery, Workload Isolation and Containerization, Regulatory Compliance Certifications, Provenance Tracking and Reproducibility, Geographic Location and Data Residency, and Dynamic Security Adjustment. These aspects/characteristics are further described as follows:
Security Features and Controls: The authentication and authorization methods employed, such as two-factor authentication and role-based access control, as well as encryption algorithms and key management practices used to protect data at rest and in transit, are specified.
Network Security Controls: The network security measures in place, such as firewalls, intrusion detection/prevention systems, and virtual private networks (VPNs), are described.
Data Backup and Disaster Recovery: The procedures and technologies used for data backup, replication, and recovery in case of system failures or disasters are outlined.
Workload Isolation and Containerization: The use of virtualization or containerization technologies to ensure workload isolation and prevent unauthorized access between different research projects is highlighted.
Regulatory Compliance Certifications: Any relevant certifications or attestations, such as HITRUST, SOC 2, FedRAMP, NIST AI Risk Management Framework, EU AI Act, US AI Executive Order, CCPA, NY AI Framework, and other regulatory guidelines, for example, that demonstrate the compute environment's compliance with industry standards and regulations are included.
Provenance Tracking and Reproducibility: Mechanisms to capture and record the computational steps, software versions, and dependencies used in data analysis to enable reproducibility and verification of results, are specified.
Geographic Location and Data Residency: The geographic location of the compute environment, and any data residency requirements to ensure compliance with data localization regulations, are specified.
Dynamic Security Adjustment: The acceptance of the implementation and application of the OaaS platform mechanisms of the illustrative embodiments to automatically adjust the security settings and controls of the compute environment based on the dataset requirements and user profile, is specified.

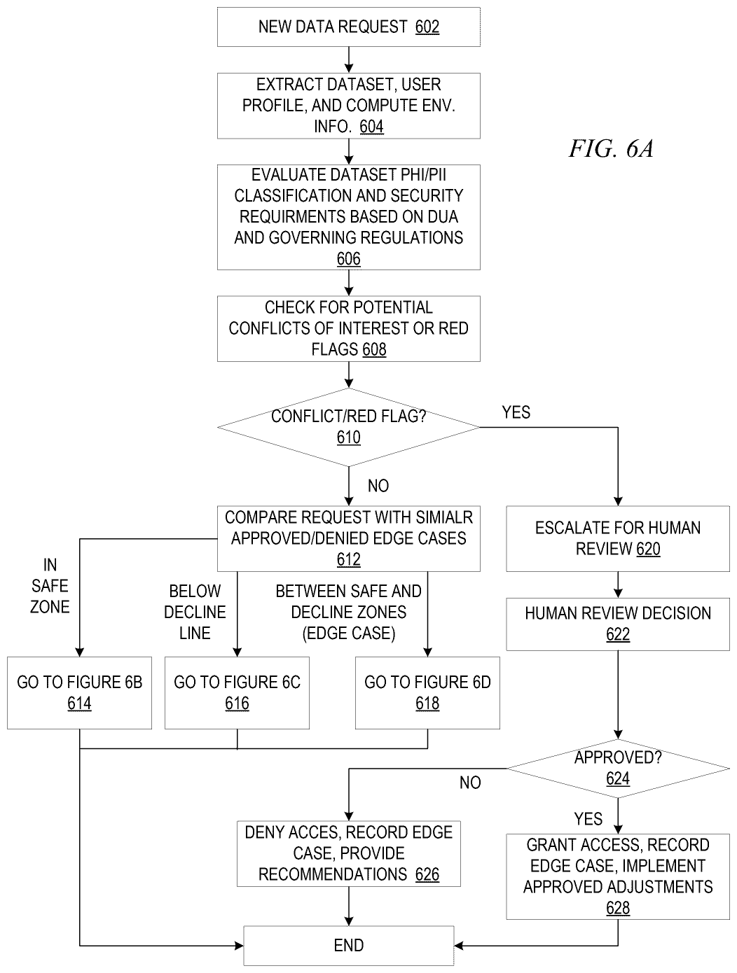

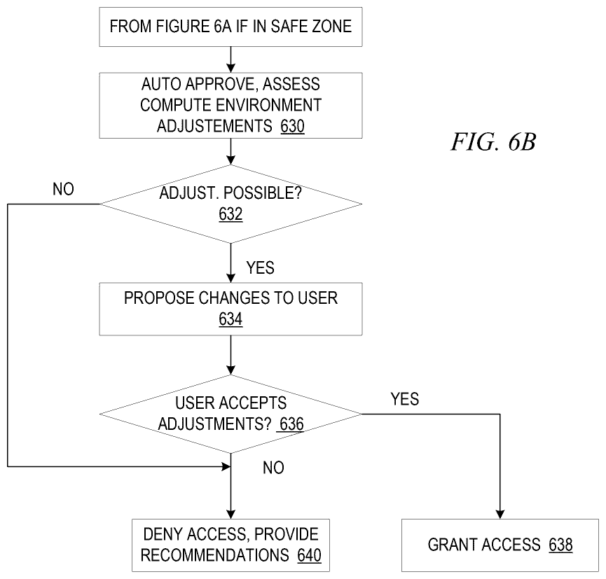

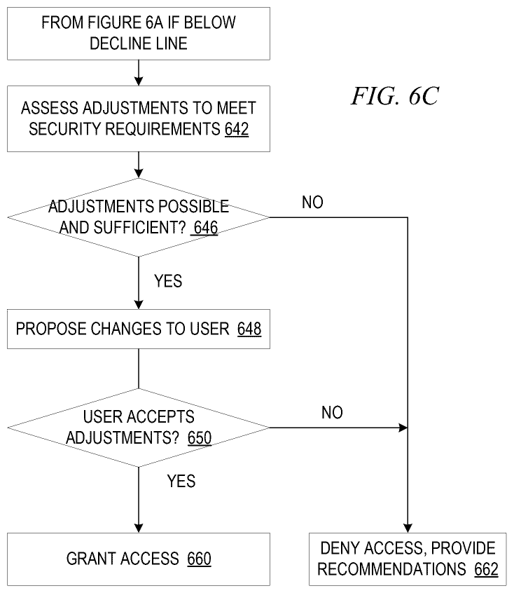

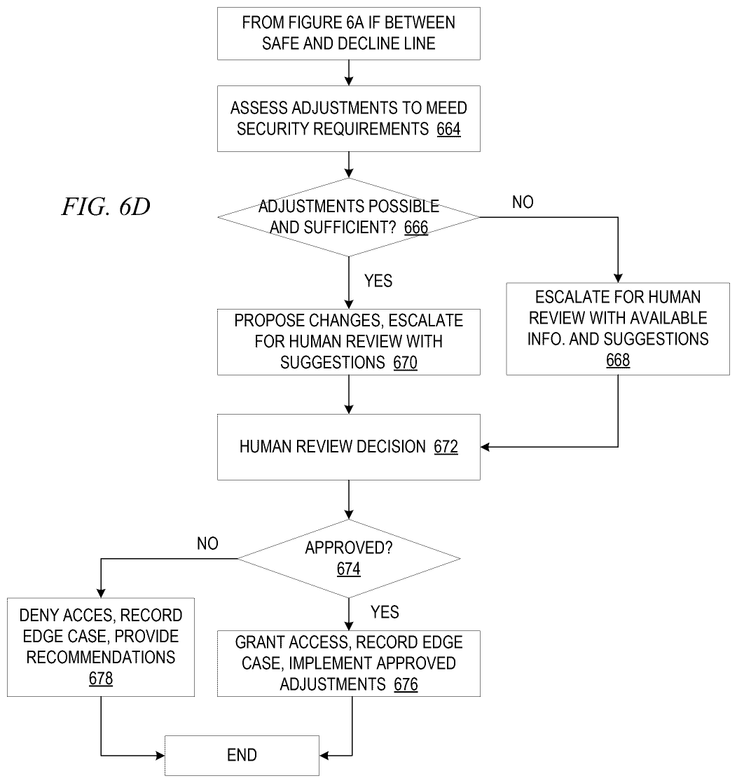

As mentioned above, with the three dimensional space of FIG. 1A as an example, when a new data access request is submitted, it is plotted within the decision space based on its characteristics, such as the user's (researcher's) profile, the requested dataset's PHI/PII classification, and the proposed compute environment. The OaaS platform then evaluates the request's position relative to the existing approved and denied edge cases and the approval-decline boundary to determine the appropriate course of action, as described in greater detail with regard to FIGS. 6A-6D.

The OaaS platform, in accordance with one or more illustrative embodiments, provides improved computer tools and improved computer operations/functionality that correlate these three dimensions to cluster new dataset access requests to clusters of previous data access request characteristics to identify whether a newly received dataset request falls into one of the clusters 102-106 in FIG. 1A and, if clustered into the edge cases, automatically determine and implement appropriate computer environment security modifications and dataset obfuscations to ensure useability of the requested dataset while maintaining security of the dataset.

For example, if a new dataset access request is clustered into or otherwise determined to be similar to boundary edge cases 106 in FIG. 1A, the OaaS platform of the illustrative embodiments operates to compare the newly received dataset access request with cases labeled as “edge cases” and determine the appropriate security level for the compute environment based on the dataset and user (e.g., researcher) profile of the user submitting the dataset access request, as may be identified in the request itself. For example, when the dataset and user profile are the same as a previously approved edge case, but the requested compute environment has a higher security level, the system can automatically adjust the compute environment to match the approval condition and auto-approve the request with the requested compute environment having the higher security level. When the dataset and user profile match, or are below, a previously denied edge case, the OaaS platform of the illustrative embodiments can auto-decline the request. When the dataset and user profile fall between previously approved and previously denied edge cases, the OaaS platform of the illustrative embodiments can propose an adjusted compute environment security level that satisfies the compliance requirements and escalate the request for further review, e.g., for human review. When the dataset and user profile are above a previously approved edge case, but the requested compute environment security level is below the previously approved case, the system can propose an adjusted compute environment security level and escalate the request for further review, e.g., human review.

Processes for reviewing and approving projects and corresponding dataset access requests may be time-consuming due to the numerous regulations governing various aspects of the research. Researchers requesting approval to perform certain research projects, for example, must prepare extensive documentation, while review committees must thoroughly evaluate each project proposal, often resulting in redundant reviews of similar or identical project components. This leads to prolonged waiting times for researchers and an increased workload for the reviewing committees, ultimately delaying the progress of research.

However, it has been recognized that many research projects share the same or similar components. By managing the project and dataset access approval process based on project components, such as those along the three dimensions of FIG. 1A above, for example, reuse of the approvals/denials may be performed where appropriate, which can significantly reduce the amount of repeated work performed and improve efficiency of project and dataset access approvals, as well as generation of analytic workspaces for users, e.g., researchers. The OaaS platform of the illustrative embodiments provides an improved computing tool and improved computing tool operations/functionality that leverage previous approvals/denials in resolving edge cases.

Moreover, with the OaaS platform of the illustrative embodiments the “security level” of the compute environment can be automatically adjusted to ensure the project meets compliance requirements without exceeding them unnecessarily. This approach allows users, e.g., researchers, to access the needed data, saving their time for scientific work, rather than having to be trained and learn how to create and provision their analytic workspaces in compliance with DUAs, security requirements, and the like. This in turn saves resources by avoiding the deployment of overly secure systems when not required.

The OaaS platform of the illustrative embodiments comprises a plurality of computer components that operate to achieve the purposes of the platform. For example, the OaaS platform comprises a data vault that provides a flexible ingestion and integration layer that understands the particular data domains and provides integration points for data quality activities across a multi-modal data ingest spectrum, e.g., voice files, video files, structured data files, unstructured data files, etc. The data vault also provides a secure petabyte-scale persistence layer having adaptive query mechanisms that can provide bulk and transaction level data exploration, query, and extraction/provisioning capabilities. The OaaS platform further provides a data linkage service utilized to link identity information, e.g., patient identities, across datasets contained in the data vault and registered in a data catalog, e.g., datasets across multiple studies or the like.

The OaaS platform further provides software and infrastructure to enable the creation and management of one or more analytic workspace environments, or simply analytic “workspaces”. In accordance with one or more illustrative embodiments, an analytic workspace is a set of cloud-based, vended capabilities that support data science related activities. These capabilities include virtual machines with data science software libraries and applications pre-installed, serverless large-scale compute frameworks, and hardware-based accelerators such as Graphics Processing Units (GPUs), Tensor Processing Units (TPUs) from Google, Intelligence Processing Units (IPUs) from Graphcore, Nervana Neural Network Processors (NNPs) from Intel, Cerebras Wafer Scale Engine (WSE) chips, and other AI-specific accelerators. The analytic workspaces may also leverage emerging computing paradigms, such as quantum computing, to tackle complex computational problems. These diverse computing resources enable researchers and data scientists to efficiently process and analyze large datasets, train sophisticated machine learning models, and push the boundaries of scientific discovery.

These vended capabilities that support data science related activities are securely provisioned in an on-demand manner, subject to approval, to the users and/or data science teams utilizing the analytic workspaces. Datasets are provisioned to the analytic workspaces by acquired the datasets from the data vault utilizing approved data process flows that utilize appropriate and approved obfuscation methods to move authorized dataset(s) into the analytic workspace to support the discovery of insights, e.g., clinical insights, and the creation of associated computable knowledge artifacts, e.g., clinical knowledge artifacts. The OaaS platform provides an analytic workspace creation and management service that is utilized to automate the creation and management of these analytic workspaces in line with approvals, processes and associated security controls, such as those specified in DUAs and role-based access control data structures.

The OaaS platform includes a data catalog which maintains a detailed inventory of all data assets located in the OaaS platform, focusing on the data vault and analytic workspaces. The data catalog is designed to assist users of the analytic workspaces to quickly find the relevant datasets for their analytic operations, and if approved, retrieve these relevant datasets for analytic operations within the analytic workspace. The datasets may include multiple versions of the datasets with varying levels of obfuscation of the PII/PHI that is present in the datasets and the data catalog may be used to find and retrieve appropriate versions of the datasets based on DUAs and role-based access controls. The data catalog utilizes metadata to describe or summarizes data to generate an informative and searchable inventory of all datasets, models, etc. located in the data vault. The data catalog comprises custom metadata scanners to generate manifests for unstructured sources, such as imaging source datasets, omics source datasets, etc. which can in turn be ingested into the data catalog to provide a multi-modal data catalog experience.

The OaaS platform provides a data obfuscation service that operates to meet confidential and sensitive information handling requirements for PII/PHI. The OaaS platform further provides data version controls as noted above. These data version controls provide computer operations and functionality to store and process datasets to produce other data or machine learning (ML) models allowing users to track, associate and save data and machine learning models, and enabling the users to create and switch between versions of data and ML models easily. The data version controls also allow parties to understand how the datasets and ML model artifacts were built in the first place, and regenerate these datasets and ML model artifacts if required.

In some illustrative embodiments, the OaaS platform may provide a marketplace for datasets in the data vault. The marketplace may provide an external viewable version of the data catalog, which hosts datasets that can be externally accessed. The marketplace supports external research collaborations through a public viewable version of the data catalog where an approved subset of data that can be accessed by external researchers is made available for viewing and searching by researchers.

In accordance with one or more illustrative embodiments, the OaaS platform is a scalable cloud infrastructure supporting the storage, compute and workload management requirements of the above components. Moreover, the OaaS platform provides required backend services to support the storage, compute, scheduling, environmental management, versioning control for associated data and models, security monitoring and tracking operations, and other operations and functionality described herein and attributed to components of the OaaS platform.

With the OaaS platform of the illustrative embodiments, upon request, and assuming appropriate approvals are obtained, the OaaS platform may create and manage an analytic workspace via the creation and management services of the OaaS platform. The creation and management services initiate the generation of the analytic workspace with all tooling, toolchains, etc., and with all necessary networking and security controls instrumented. Upon completion of this provisioning operation, a notification may be sent to user that requested the analytic workspace, and the initiation of a data publication service is triggered to move data into the analytic workspace from the data vault, with appropriate obfuscation processing of PHI/PII being applied in accordance with applicable DUAs and role-based access controls. Once analytic workspace data publication is complete, e.g., the appropriate version of the dataset(s) are provisioned to the analytic workspace, a notification is sent to the user, and a clock is triggered for environment duration tracking.

The user of the analytic workspace is provided full access to the datasets published to that analytic workspace in accordance with role-based access controls and data usage agreements (DUAs) associated with the datasets and particular user. The user can perform various tasks on the dataset, and commit/push the result back to the data catalog, e.g., new versions of the datasets may be stored in the same data repositories (repos) of the data catalog for minor changes, or a new data repository (repo) may be generated if the output is significantly different from the original dataset. The DUAs and role-based access controls determine the tasks that may be performed as well as what levels of obfuscation are to be applied to PII/PHI when the datasets are provisioned to the analytic workspace. Moreover, the clock may be used as a basis for complying with duration permissions/restrictions set forth in the DUAs.

Thus, the OaaS platform of the illustrative embodiments provides an improved computing tool and improved computing tool operations/functionality for dynamically creating and managing analytic workspaces and controlling obfuscation of datasets, models, etc., of a data vault when provisioning these datasets, models, etc., to the dynamically created/managed analytic workspaces. The illustrative embodiments provide advantages over existing computing systems in that the OaaS platform provides a data vault and dataset access control mechanisms that leverages previous approvals of dataset access requests for various projects to generate analytic workspaces and adjust the security level of compute environments automatically to meet the security requirements of the particular dataset access. Moreover, these operations are performed based on the individual pairings of particular users and datasets associated with a received request for access to a specified dataset, and can automatically adapt the compute environment to the necessary security level required to approve the request from the user for access to the specified dataset.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an Obfuscation-as-a-Service (OaaS) platform. The improved computing tool implements mechanism and functionality, such as dynamic creation and management of analytic workspaces with appropriate obfuscation of PII/PHI or other sensitive/confidential information in accordance with automatically enforced DUAs and role-based access controls, which cannot be practically performed by human beings either outside of, or with the assistance of, a technical environment, such as a mental process or the like. The improved computing tool provides a practical application of the methodology at least in that the improved computing tool is able to automatically and dynamically obfuscate/mask data files of datasets stored in a data vault and provision or publish those datasets to automatically and dynamically generated analytic workspaces with smart filtering such that protected information, e.g., PII/PHI, is not accessible by unauthorized individuals in the analytic workspaces.

FIG. 1B is an example diagram illustrating the relationship between components of an Obfuscation-as-a-Service (OaaS) platform and the corresponding smart filtering in accordance with one illustrative embodiment. As shown in FIG. 1B, the OaaS platform 100 includes data catalogs 110 and data vault 120 and applies smart filtering mechanisms 130-150 when provisioning or publishing datasets to dynamically generated analytic workspaces. These smart filtering mechanisms 130-150 automatically and dynamically apply data usage agreements (DUAs) and their corresponding role-based access controls (RBACs) to datasets that are to be operated on by users within the various dynamically generated workspaces 160, 170 and when datasets are provisioned from one analytic workspace to another, e.g., smart filter 150 acting on datasets shared between workspace 170 and workspace 160. The datasets that are stored in the data vault 120 and cataloged in the data catalog 110 may be multi-modal, e.g., video, images, structured data, unstructured data, and the like, and may come from a variety of different source computing systems 180.

In accordance with the illustrative embodiments, a user may log onto the OaaS platform 100 and request access to a particular dataset in the data vault 120. The OaaS platform 100 comprises components, described hereafter, which operate to automatically process the information in the data request form submitted by the user, to determine whether the user is permitted access to the dataset and if so, what level of access the user is to be afforded in accordance with a DUA and corresponding RBACs associated with the particular pairing of the user and the dataset. Smart filtering is then performed on the dataset when provisioning or publishing that dataset to the corresponding dynamically generated analytic workspace 160 or 170 for that user. This may involve not only obfuscating/masking portions of the dataset based on the level of access the user has to the data, but also may involve automatically enabling/disabling tools within the dynamically generated analytic workspace 160, 170 based on the user's permissions with regard to operations that can be performed with the dataset. Thus, different filtering may be applied to the dataset through smart filtering 130, 140, and 150 to ensure compliance with security and/or privacy requirements, represented in the DUAs and RBACs.

Based on the work performed by the user(s) on the datasets within the analytic workspaces 160, 170, the user(s) may decide to publish the results of their work to a public marketplace 190, which may be a publicly viewable subset of the data catalog 110, for example, for sharing with other users. These datasets may comprise data structures, AI computer models, and the like, which may be operated on by users in the dynamically generated analytic workspaces. The analytic workspaces may be referred to as having different types of workspaces, e.g., obfuscated workspace 160, sensitive workspace 170, and the like, which refers to the level of access and obfuscation/masking of datasets that is performed within those workspaces for the particular pairing of user and dataset. For example, a confidential workspace 160 may require no obfuscation/masking of sensitive data as the DUA and RBACs do not put any restriction on the user with regard to accessing the dataset, e.g., an owner of the dataset may be provided unrestricted access to the dataset. A sensitive workspace 170 may have some sensitive information being obfuscated/masked based on the specifications in the DUA and RBACs, e.g., removing/replacing certain portions of datasets deemed to be sensitive information to be obfuscated, while other portions are not removed/replaced. Still further, although not shown in FIG. 1B, some workspaces may require full obfuscation/masking of sensitive information in which case datasets may have smart filtering applied that removes/replaces all sensitive information in order to prevent the user from access any data determined to be sensitive.

The OaaS platform 100 further includes components, as will be described in greater detail hereafter, for dataset owners to add their datasets to the data vault 120 and associated DUAs and RBACs with different users and/or user roles. Moreover, these dataset owners are also provided with functionality by the OaaS platform 100 to generate and store different obfuscated/masked versions of their datasets for provisioning to analytic workspaces in accordance with applicable DUAs and RBACs. Appropriate data structures are maintained by the OaaS platform 100 for correlating the primary datasets with the various versions of that dataset, their storage locations in the data vault 120, and the like, so as to facilitate application of DUAs and RBACs to particular pairings of users and datasets and provisioning or publishing datasets to dynamically generated analytic workspaces, e.g., 160, 170.

It should be appreciated that one of the benefits of the improved computing tool and improved computing tool operations/functionality of the illustrative embodiments is the ability to generate analytic workspaces, and automatically provision them with the tools and dataset versions in accordance with established DUAs and RBACs, and the particular user profiles of users requesting access to the datasets, in an on-demand manner. That is, the user need not negotiate the DUAs and RBACs each time the user wishes to access datasets from the data vault 120. To the contrary, the user need only submit a data request form and the architecture of the OaaS platform 100 automatically handles all the necessary operations for dynamically generating the analytic workspace environment for the user to access the dataset, and for automatically provisioning the tools and version of the dataset for the user to work on in the dynamically generated workspace, in accordance with the appropriate DUA and RBACs for that particular pairing of the user and the dataset.

As shown in FIG. 1B, one or more of computing devices, e.g., servers, may be specifically configured to implement a OaaS platform, such as OaaS platform 100. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates providing obfuscation of data as a service.

By stating that the obfuscation of the data is provided “as a service” means that the OaaS platform 100, in some illustrative embodiments, provides a cloud-based mechanism for providing software and/or infrastructure components for performing data obfuscation functionalities to which one or more users can subscribe and access via one or more data networks. Thus, the OaaS platform 100 is specific to computing technology and is specifically configured to solve the issues in existing computing environments with regard to establishing and applying data usage agreements (DUAs) and role based access controls (RBACs) in an automated and dynamic manner without having to engage in time consuming and resource intensive negotiations of such DUAs and RBACs prior to a user being able to perform operations on a dataset via an analytic workspace.

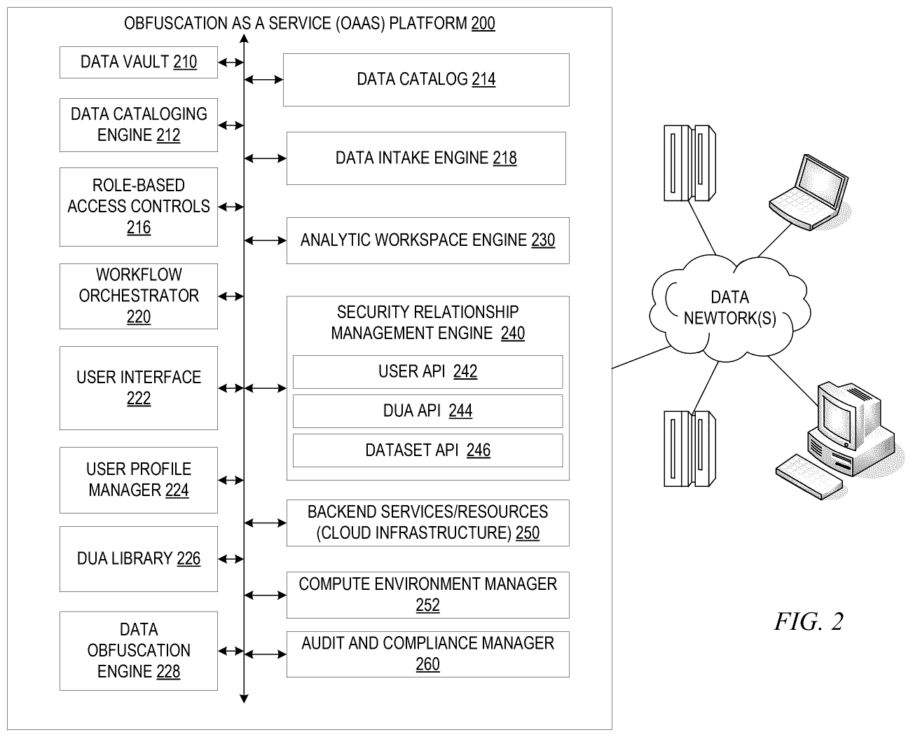

FIG. 2 is an example block diagram of the primary operational components of an Obfuscation-as-a-Service (OaaS) platform in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way in which analytic workspaces are dynamically and automatically created, maintained, and provisioned with datasets in accordance with DUAs and role-based access controls, and providing a specific solution that implements an Obfuscation-as-a-Service (OaaS) platform, which cannot be practically performed by human beings as a mental process and is not directed to organizing any human activity.

As shown in FIG. 2, the OaaS platform 200, which may be used to implement the OaaS platform 100 in FIG. 1B, is realized through the implementation and integration of several main technical components. The OaaS platform 200 includes a data vault 210 which is a secure, centralized repository that stores and manage diverse multi-modal datasets accessible for analytic operations in one or more analytic workspaces, e.g., for research utilization or the like. The data vault 210, in some illustrative embodiments, has an ingestion layer, integration layer, and data persistence layer. The ingestion layer provides interfaces to acquire data in bulk and interfaces for facilitating various streaming modalities: structured data (e.g., discrete, JSON, XML), semi-structured data, time series and signal data, Digital Imaging and Communications in Medicine (DICOM) images, genomic data, general document types, and the like. The data vault 210 facilitates the adding or ingesting of new dataset data types, e.g., study data types, or data formatted via various standards.

Upon acquisition of the data, the integration layer of the data vault 210 provides tooling and capabilities that support data integration across a multi-modal source spectrum, such as life sciences, manufacturing, retail, healthcare research, and other domains involving diverse data types and sources. Tooling to support data quality, data association, data transformation, lineage and provenance recording, logging capabilities, and cataloging of the multi-modal data space is provided as a native part of the ingestion and/or integration layers in the data vault 210. The cataloging of the multi-modal data is utilized with subsequent access request generation and retrieval of information subsets from the data vault. The data vault 210 classifies datasets based on the level of personal health information (PHI) and/or personally identifiable information (PII) that the dataset contains and associated metadata related to data source, provenance, quality metrics, usage restrictions, subject demographics, collection methods, update frequency, and version control. The data vault 210 supports the decision making process by providing a secure and organized storage environment for datasets, along with the necessary metadata to evaluate their security requirements and usage restrictions.

The data persistence layer of the data vault 210 is scalable to multiple petabytes and provides appropriate technologies to store the various dataset data types, e.g., healthcare study data types, including structured, semi-structured, imaging, genomic, and time-series (signal and telemetry) data, for example. In some illustrative embodiments, an example of these technologies may include IBM Cloud Pak for Data available from International Business Machines (IBM) Corporation of Armonk, New York, and/or the like, however the illustrative embodiments are not limited to this particular technology in order to implement the data persistence layer of the data vault 210 and other technologies that may provide a persistence layer may be used without departing from the spirit and scope of the present invention. The data acquired and integrated in the data ingestion and integration layers is persisted and organized to minimize the amount of data duplication and may be presented as a coherent individual patient record.

It should be noted that the organizational principles of the data vault 210 focus on a flexible approach to lightly integrating data across multiple types and sources, such as structured records linked to unstructured data, images, and other domain-specific information. For example, in the healthcare domain, this could involve linking electronic health record (EHR) medical record data to Digital Imaging and Communications in Medicine (DICOM) images and genomic information. The data vault structures facilitate the persistence and delivery of data in a straightforward manner. The primary objective in this layer is to be easily and rapidly expandable to support existing data domains and accommodate the addition of new data domains as needed.

The OaaS platform 200 further comprises data cataloging engine 212 that implements computer executed logic of a data cataloging function to support data discovery and classification operations. The data cataloging engine 212 operates to develop and store a data catalog 214 comprising metadata about the diverse multi-modal datasets in the data vault 210 in order to make them accessible for subsequent utilization, e.g., research utilization. The resulting data catalog 214 may operate with role-based access controls 216 and attribute-based access controls to manage and govern data catalog 214 utilization for internal and external users, e.g., determine which data catalog 214 entries are viewable by different roles of users and enforce access policies based on user attributes and dataset attributes.

The data catalog 214 is a comprehensive inventory of all datasets stored in the data vault 210. The data catalog 214 captures and maintains metadata about each dataset, facilitating data discovery, classification, and lineage tracking. The data catalog operates in conjunction with the role-based access control system 216, attribute-based access control policies, and security relationship management engine 240 to ensure that only authorized users can view and access dataset metadata based on their permissions, user attributes, dataset attributes, and the dataset's PHI/PII classification. The data catalog 214 also includes a user-friendly interface for users (e.g., researchers) to browse, search, and request access to datasets from the data vault 210. The data catalog 214 supports the decision-making process by providing a centralized repository of dataset metadata, enabling the system to quickly retrieve the necessary information for evaluating data access requests and determining the appropriate security requirements.

Thus, the data catalog 214 of the OaaS platform may operate as a marketplace for datasets and thus, provides computer resources and logic to support external user collaboration. The data catalog 214 may provide marketplace logic for presenting a publicly viewable version of the datasets in the data vault 210 that can be accessed by external users. Through the data catalog 214, users (e.g., researchers) can share their datasets and other users can submit data requests to gain access to these datasets. One can consider the data vault 210 as the secured backend that actually stores all the datasets, and the data catalog 214 with the marketplace logic being the frontend for users to search and preview what is available for requesting access.

The data cataloging service provided by the data cataloging engine 212 support both structured and unstructured data from a data governance of authorized users. The data cataloging service further supports scanning, discovery and classification of inbound source datasets into the data catalog 214 which supports multiple data source infrastructure patterns. The scanning, discovery and classification capabilities of the data cataloging service of the data cataloging engine 212 can be customized and the metadata be extended based on taxonomies of the fields of interest, e.g., research or business. The data cataloging service has the ability to generate a metadata tag designating whether or not a field or attribute contains PII/PHI or not. This tag is added to the metadata in relation to a data source if required utilizing key-value pairs. The definition and generation of the metadata occurs through the utilization of a customizable deep-inspect agent of the data cataloging engine 212 to identify the presence of PII/PHI in the data source.

The OaaS platform 200 further includes data intake engine 218 which provides an interface through which information about the various datasets, models and the like, that are to be added and maintained in the data vault 210 may be obtained. In some illustrative embodiments, this interface may include an intake form that a user, e.g., a researcher, may populate in order to have their datasets, models, or other relevant artifacts loaded to the data vault 210 and cataloged by the data cataloging engine 212. In other illustrative embodiments, information about the datasets, models, etc., may be obtained automatically by the data intake engine 218, such as by processing metadata data structures associated with the datasets, models, and the like. Of course a hybrid approach of automatically identified and manually specified information about the datasets, models, and the like, may be utilized to store and maintain the datasets, models, etc. in the data vault 210 and have them cataloged by the data cataloging engine 212 into the data catalog 214.

The information about the datasets, models, etc., may comprise various types of information that can assist with storage and retrieval of datasets, models, etc., hereafter collectively referred to as simply “datasets” to represent any data structure that is to be stored and maintained in the data vault 210 for subsequent retrieval and analytic processing. For example, the information obtained via the intake form, automatic identification from metadata, or any combination of automated and manual processes, may include general information about the dataset, such as the program/study name that is associated with the dataset, research pillar (area), key contract details, sponsor/manager/executive details, etc. This general information may be used to determine the approval path within the data owner organization used to approve and/or associate DUAs and/or role-based access controls with particular combinations of users and datasets.

Additional information about the dataset may include Data Usage Agreement (DUA) Information (such as Common Controls Framework (CCF) specifics including privacy, consent, etc.), high level dataset description information for approval purposes (detailed metadata may also be included or uploaded/edited after approval), data classification and privacy information, and data retention and storage information (e.g., specifying duration and location of dataset storage/maintaining). In addition, other optional information that may be included, such as analytic workspace tooling requirements, e.g., study tooling requirements (such as Docker file, Python requirements.txt, etc.), for the purpose of documentation for future reproducibility. Other optional information may include environment requirements, such as study recommended environment configures, e.g., Central Processing Unit (CPU) requirements, memory requirements, Graphics Processing Unit (GPU) requirements, etc.

The data intake engine 218 provides a data movement service to securely and reliable move the submitted datasets into the data vault 210. For example, if a user (e.g., researcher) is conducting a study and has generated a dataset, at the request of the researcher, the data intake engine 218 may move the dataset into the data vault 210, after appropriate approvals if any, and may acquire the dataset information either manually from the intake form, automatically by processing metadata of the dataset, or through a semi-automated process combining the two. This data movement service of the data intake engine 218 may operate in conjunction with the data cataloging engine 212 to generate one or more corresponding entries in the data catalog 214.

It should be appreciated that the data intake engine 218 may obtain the dataset information for various different types or domains of datasets and, with regard to manual or semi-automated intake of datasets, may provide different intake forms for different domains, different studies, or other dataset submission types. In various embodiments, the intake forms may be self-certification submissions while others may be third party submissions.

The OaaS platform 200 includes role-based access controls 216 which may operate on the data catalog 214 to manage and govern data catalog 214 utilization for internal and external users via the user interface 222. In addition to role-based access control (RBAC), the OaaS platform 200 also incorporates attribute-based access control (ABAC) at a finer granularity, allowing for more dynamic and flexible control over access to datasets and other artifacts. ABAC enables proactive automated access policy enforcement in real-time, applying dynamic data tokenization for data privacy while allowing users to query data without changes to their workflows. It also enables continuous monitoring of data usage across the platform, helping define security postures that support varying sensitivity levels and risk profiles depending on the nature of the work. Furthermore, ABAC ensures compliance adherence via policy enforcement at various levels, such as file, table, row, column, cell, or object level.

Access policies can be set at the study, dataset, model, or other artifact level to limit access entirely or to certain aspects, and these policies can be applied across multiple studies or datasets. The policies are enforced to limit user access as they browse the catalog or are granted access to data published to workspaces. Policies could define and enforce dataset restrictions, obfuscation, masking, or tokenization methods, and other access control rules. Over time, the system of the illustrative embodiments may automatically apply processes based on data and attribute classification to drive a higher level of automation into the OaaS platform.

The user interface 222, operating in conjunction with role-based access controls 216 and attribute-based access controls, may allow authorized users to see all entitled artifacts (e.g., datasets, models, etc.) in the data vault 210. These entitled artifacts may be filtered by various categories in the interface 222 (e.g., research type, specialty, researcher, data modality, access rights (copyrighted or not), consent/ethical considerations, etc.). The role-based and attribute-based browsing and searching of the data catalog 214 via the user interface 222 may also allow authorized users to look at the dataset information, e.g., study information, detailed attribute definition of the datasets, viewing sample data values (PII/PHI masked), with the ability to perform sub-setting/filtering of the datasets and viewing sample analytic code.

For example, assume an implementation in which the datasets are classified based on the level of Protected Health Information (PHI) or Personally Identifiable Information (PII) they contain, such as “Full PHI/PII,” “Partial PHI/PII,” or “No PHI/PII.” This classification allows the system to determine the level of scrutiny required for each dataset and facilitates the identification of previously approved datasets with matching PHI/PII levels. In order to classify a dataset, various analyses may be applied to the dataset including, but not limited to analyses that determine whether the dataset contains one or multiple instances of PII information that allows identifying an individual person, or PHI information that allows identifying the health status of an individual person. If this determination is negative, i.e., the dataset does not include any PHI/PII or such information has been removed, then the dataset may be classified as “No PHI/PII” or no obfuscation.

If this determination is positive, then the dataset may be classified as either Full or Partial PII/PHI depending on the circumstances. For example, this dataset is classified as “Full PII/PHI” where full obfuscation may be appropriate. The determination of whether a dataset includes PII/PHI may include determining if the dataset includes one or more electronic document data structures (also referred to herein as simply a “document”) that contains the PII/PHI defined by HIPAA, GDPR or other regulations. This determination may further include determining if an electronic health record (HER) document includes such PII/PHI, determining if a video recording or image with a person's face is present in the dataset, determining if an audio recording with a person's name and other PHI/PII is explicitly mentioned in the dataset, determining if DNA/fingerprint/voiceprint or other biometric data are present in the dataset, and the like.

With regard to the dataset containing a “partial” PHI/PII information and requiring partial obfuscation, a dataset may fall into this category for example, if it includes one of the following cases, or the like. The data in the dataset does not include data classified as PHI/PII in accordance with the existing technology, but there is still a chance to identify a person using the data when new technology emerges, or when combined with other datasets and using sophisticated data mining algorithms. The types of data that meet this criteria may include, but is not limited to, a video recording of a person's gait movement, an audio recording of a person's voice (even though PHI/PII may not be explicitly mentioned or there is not enough audio data to be a voiceprint) which if combined with other information may be uniquely identifying of the individual, e.g., if combined with geospatial information of the audio recording. As another example, the dataset may be considered requiring “partial” obfuscation if the dataset comprises data in which PHI/PII has been partially obfuscated, such as the name and social security number (SSN) in an EHR having been removed, but a date of birth (DOB) is still present, the name and SSN are partially masked (e.g., viewing only name initial, or last 4 digits of SSN), or an image with the face of a person being mosaiced.

The data intake process, such as performed by the data intake engine 218 of the OaaS platform 200, may operate to classify the raw datasets into one of the above categories. Moreover, in some illustrative embodiments, the PHI/PII obfuscation mechanisms of the illustrative embodiments may obfuscate or mask portions of the datasets to create “partial PHI/PII” or “no PHI/PII” versions of the dataset to provide derivative datasets and thereby allow more users, e.g., researchers, that may have lower role-based access levels to use the portions of the dataset that do not have PHI/PII in their operations within the generated analytic workspaces. This also reduces the risk and management overhead of distributing PHI/PII in unnecessary situations.

The user interface 222 may further include web user interface (UI) which provides linkages to external dataset description web pages, e.g., study description pages, that provide detailed information on the datasets, e.g., the research study datasets, which may in turn allow for the preview of example data, additional dataset information, sample analytic code, etc. The web UI of the user interface 222 further provides a web UI that supports browsing individual datasets, such as with a GitLab™ fashioned repository supporting dataset review with commit (snapshot) history review. A commit, as it is known in the GitLab™ technology, refers to an operation to persist changes and associate with the files a new unique identifier, e.g., a hash of the files.

The user interface 222 may further provide an interface through which a user may request the dynamic and automated creation of an analytic workspace and the provisioning, or publication, of one or more datasets from the data vault 210 to the analytic workspace that is created. This user interface may provide and process request forms submitted by a user and may operate in conjunction with the data catalog 214 to provision appropriate versions of datasets from the data vault 210 to analytic workspaces in accordance with applicable DUAs from the DUA library 226 and role-based access controls 216, as determined by the security relationship management engine 240, as discussed hereafter. Thus, the user interface 222 may further comprise logic that supports a request form for users, e.g., researchers, to request access to datasets in the data vault 210 that in turn will trigger required approval processes (Institutional Review Board (IRB) approval, data owner approvals, etc.) when initiated.

The actual request form may take many different forms depending on the desired implementation, but in general will have fields for specifying criteria of the particular dataset(s) that are desired to be provided to the analytic workspace. For example, a data catalog access request form may specify study details of interest, dataset details including necessary PII/PHI requests and justifications (e.g., with a whitelist approach, default filter will remove all the other PII/PHI that is not requested), continuous syndication (subscription mode: automatically receiving new dataset update push), or one time hydration of data to the analytic workspace (manual mode: receiving a fork of main branch at the time of request; users can perform “fetch upstream” to receive dataset updates), duration request, data residency, and desired tooling, compute, memory, and storage configurations. The submitted form may be processed with acknowledgement of dataset and/or tool licensing requirements and approved/denied in accordance with established DUAs and role-based access controls. This may include routing the request to appropriate personnel for approval or denial of the request.

The OaaS platform 200 further includes a workflow orchestrator 220. The workflow orchestrator 220 coordinates the various operations involved in the data access request processing, from submission and review to the provisioning of datasets and compute environments for analytic workspaces. The workflow orchestrator 220 integrates with the data catalog 214, researcher profile manager 224, role based access control system 216, security relationship management engine 240, and compute environment manager 252 to automate the flow of information and decisions throughout the dataset access request lifecycle. The workflow orchestrator 220 also incorporates notification and alerting mechanisms to keep users informed about the status of their requests and any required actions. The workflow orchestrator 220 plays a role in implementing the decision-making process by ensuring that each operation is executed in the proper order and that all necessary information is collected and considered at each stage of the process.

The OaaS platform 200 also includes a user profile manager 224. This component manages user profiles, which contain various labels and elements related to characteristics of the user, such as, in the case of a researcher, the user's institutional affiliation, research track record, conflict of interest disclosures, data security and privacy training, collaborator information, IRB approvals, and DUA acceptance. The user profile manager 224 integrates with the role-based access control system 216 and security relationship management engine 242 to determine a user's level of access to datasets in the data vault 210 based on their qualifications, training, and project-specific requirements. The user profile manager 224 supports the decision-making process by providing the necessary information about the user's background, qualifications, and potential conflicts of interest, which are factors in determining the appropriate level of access to sensitive datasets.

The OaaS platform 200 further includes a compute environment manager 252. The compute environment manager 252 manages the provisioning, configuration, and monitoring of secure compute environments for researchers to analyze datasets and may work in conjunction with the analytic workspace engine 230 to dynamically generate analytic workspaces and provision appropriate compute environment tools in the dynamically generated analytic workspaces for use by users when performing their work on datasets. The compute environment manager 252 ensures that each compute environment meets the necessary security, compliance, and data protection requirements based on the PHI/PII classification of the datasets being analyzed. The compute environment manager 252 incorporates features such as workload isolation, data encryption, network security controls, backup and disaster recovery mechanisms, and provenance tracking to maintain the confidentiality, integrity, and availability of sensitive healthcare data. The compute environment manager 252 further comprises logic for automatically modifying the compute environment to meet the data obfuscation requirements and other security requirements for approving dataset access requests from users, i.e., automatically adapting the compute environment to provide the required level of security for accessing datasets. The compute environment manager 252 supports the decision-making process by providing the flexibility to adjust the security settings and controls of the compute environment based on the specific requirements of each data access request, enabling the system to propose and implement appropriate security measures to meet the dataset's requirements.

The OaaS platform 200 also includes an audit and compliance manager 260. The audit and compliance manager 260 captures and records all data access requests, decisions, and actions taken by the OaaS platform 200 for auditing and compliance purposes. The audit and compliance manager 260 logs information about the datasets accessed, the user (researchers) involved, the compute environments used, and any data transformations or analyses performed. The audit and compliance manager 260 generates reports and provides tools for compliance officers to monitor adherence to data privacy regulations, such as HIPAA and GDPR, and to investigate any potential breaches or unauthorized access attempts. The audit and compliance manager 260 supports the decision-making process by maintaining a record of all access decisions and actions, enabling the OaaS platform 200 to demonstrate compliance with relevant regulations and to provide transparency into the decision-making process for auditing and monitoring purposes.

The OaaS platform 200 further includes the DUA library 226 which is a repository that stores the records of human-reviewed data access requests, along with the associated decisions, rationales, and any approved adjustments to the user's profile, compute environment security settings, or PHI/PII obfuscation/masking. The DUA library serves as a valuable resource for the decision-making process, as it provides a set of reference cases that the OaaS platform 200 can use to compare new access requests and make informed decisions. As the number of edge cases in DUA library grows over time, it continuously improves the OaaS platform's ability to automatically approve or deny requests that closely match previously reviewed cases, while also identifying the cases that require human expertise for a more nuanced evaluation.

The OaaS platform 200 also includes a data obfuscation engine 226 that provides a data obfuscation service to process PII/PHI contained in the datasets of the data vault 210 as they are stored into the data vault 210 and/or are provisioned or published from the data vault 210 to the analytic workspaces. The target analytic workspace can have varying levels of access to PII/PHI based on the associated DUAs and role-based access controls associated with the particular user that initiated the analytic workspace creation and the particular dataset(s) being published to the analytic workspace. For example, in some illustrative embodiments, analytic workspaces may have levels of access that correspond to the full, partial, or no PHI/PII classifications previously discussed above. For example, a first dataset space may one for storing and machine handling of raw data that has Full PHI/PII, which needs the highest security, e.g., no researcher direct access, such that only a few system administrators with proper training and certifications can access this raw data for system maintenance purposes. A second dataset space may be the partial PHI/PII space which may be provided for access by users, e.g., researches, in the analytic workspaces and which needs to access certain PHI/PII information and where, when data is being moved into this space, all the not-needed PHI/PII is removed or obfuscated/masked. The third dataset space may be the no PHI/PII space, which is for all the other cases, e.g., the user (e.g., researcher) does not need any PHI/PII information, or the dataset itself does not contain PHI/PII.

The obfuscation of PHI/PII when ingesting datasets into the data vault 210, and/or or when provisioning analytic workspaces, may take various forms including deletion, replacement with replacement text/values that do not expose the PII/PHI, or the like. In some illustrative embodiments, for structured datasets, e.g., table data structures or the like, the obfuscation may involve masking selected columns or key-values in the structured datasets. For unstructured datasets, natural language processing and artificial intelligence models may be used to process unstructured text to filter and/or replace PII/PHI, e.g., the natural language processing (NLP) may be used to identify entity mentions within the unstructured text based on an ontology or knowledge base that identifies specific instances and/or types of entity mentions that are considered PII or PHI. For example, the entity mention filtering may involve looking for first name, last name, social security number, date of birth, address, or any other PII or PHI.

The data obfuscation engine 228 may operate to generate various stored versions of datasets that have had various levels of obfuscation in the data vault and link them to the principle non-obfuscated version for later use in provisioning analytic workspaces by the operation of the analytic workspace engine 230 and compute environment manager 252. In some illustrative embodiments, this versioning or obfuscation may be performed on-demand or dynamically in response to a request to access a particular dataset. In either case, the data obfuscation engine 228 leverages existing agreed upon data usage agreements (DUAs) and attribute-based access control policies to support data publication from the data vault 210 to dynamically created analytic workspaces that are dynamically created by the analytic workspace engine 230 in response to approvals of dataset access requests. The data publication service of the data obfuscation engine 228 can be conceptualized as a PII/PHI masking operation when publishing the dataset to the analytic workspace, with a data repository (repo) forking operation, i.e., a process whereby the resulting dataset with the obfuscation/masking applied is copied back to the data vault 210 so as to store various versions of the dataset with differing levels of obfuscation/masking which can thereafter be retrieved to service subsequent dataset access requests. It should be appreciated that the various versions of the dataset may be cataloged by the data cataloging engine 212 into the data catalog 214, which in turn may be viewable in accordance with the role-based access controls 216 and attribute-based access control policies.

The DUAs themselves may specify particular users, roles, access controls, life cycles, and other attributes of the agreement that dictate how particular users/roles may operate on a corresponding dataset associated with the DUA. The DUAs, in some illustrative embodiments, may be data structures with a Structured Query Language (SQL) many-to-many relationship. There may be general DUAs that may be associated with the datasets, i.e., the same DUA may apply to a plurality of different pairings of user/role and dataset. For example, a first type of DUA may be a user DUA, a second type of DUA may be an “owner” DUA, and a third type of DUA may be an “editor” DUA, each of which having their own sets of attributes of roles, access controls, life cycles, etc. which can be applied to a plurality of different pairings of specific users with specific datasets. For example, an editor DUA may specify that the user can change the content of the dataset and push commits back to the dataset in the data vault 210. The user DUA may specify whether the user an access certain PII/PHI and the length of time that this access may be performed, along with other permissions. The owner (or admin) DUA may specify that users with this role of “owner” or “admin” can add/remove other people and change permissions and DUAs and has all editor privileges. The DUAs are customizable to the desired implementation.

The OaaS platform 200 further includes an analytic workspace engine 230 that provides an analytic workspace creation and management service. The analytic workspace creation and management service automates the creation of a user's analytic workspace with all approved compute resources, storage resources, software tooling, toolchains, etc., together with necessary security access controls configured and linked to approved templated requests to support insight generation against the analytic workspace dataset(s). The analytic workspace engine 230 manages requests for additional compute and storage resources, performs analytic workspace maintenance operations, such as patches, fixes, and the like, and provides on-going environment notifications as certain thresholds are met, e.g., duration times relative to DUA and/or role-based access control limitations. The analytic workspace engine 230 further provides computer logic and functionality for scheduling support job submission for centralized compute resources, as well as the deprovisioning of the analytic workspace environment when conditions require the deprovisioning or when the user no longer is utilizing the analytic workspace.

When a user submits a request, e.g., through a request form or the like, for an analytic workspace and access to a dataset from the data vault 210, the user's request is processed for approval. The analytic workspace engine 230 operates, in conjunction with the role-based access controls 216, data catalog 214, and other components of the OaaS platform 200 to process new dataset access requests, to determine if these dataset access requests fall into the safe zone, decline zone, or edge cases (see discussion of FIG. 1A above). That is, the new dataset access request characteristics are clustered with previously processed data access requests to determine which cluster they fall into. For those falling into the decline zone, the new dataset access request is denied. For those falling into the safe zone, the new dataset access request is approved and corresponding safe zone security is applied when provisioning the analytic workspace with the dataset. For those falling into the edge cases, further analysis and processing is performed to determine the level of security needed and the compute environment to be provided in the analytic workspace.

With these edge cases, the analytic workspace engine 230 operates to compare the newly received dataset access request with cases labeled as “edge cases” and determine the appropriate security level for the compute environment based on the dataset and user (e.g., researcher) profile of the user submitting the dataset access request, as may be identified in the request itself. In some illustrative embodiments, this comparison is performed by generating a corresponding point in a project space, e.g., see FIG. 1A, for the request and comparing it to other points in the project space for other previously approved/denied dataset access requests to determine whether to automatically approve/deny the request or to elevate the request to a more nuanced review by a human reviewer.

For example, when the dataset and user profile are the same as a previously approved edge case, but the requested compute environment has a higher security level, the system can automatically adjust the compute environment to match the approval condition and auto-approve the request with the requested compute environment having the higher security level. When the dataset and user profile match, or are below, a previously denied edge case, the analytic workspace engine 230 can auto-decline the request. When the dataset and user profile fall between previously approved and previously denied edge cases, the analytic workspace engine 230 can propose an adjusted compute environment security level that satisfies the compliance requirements and escalate the request for further review, e.g., for human review. When the dataset and user profile are above a previously approved edge case, but the requested compute environment security level is below the previously approved case, the system can propose an adjusted compute environment security level and escalate the request for further review, e.g., human review. This process will be described in greater detail hereafter with reference to FIGS. 6A-6D.

Upon request approval, the analytic workspace engine 230, in conjunction with the compute environment manager 252, initiates the generation of the analytic workspace with all tooling, toolchains, etc., and with any necessary networking and security controls instrumented. Upon completion of this provisioning step, the analytic workspace engine 230 sends a notification to the user indicating that the analytic workspace has been created and provides the necessary information for the user to access the analytic workspace, e.g., a link to the analytic workspace. The analytic workspace engine 230 then automatically invokes the data publication service of the data obfuscation engine 228 to provision or publish the requested dataset(s) into the generated analytic workspace. This provisioning or publishing is performed with the appropriate obfuscation of PII/PHI being applied in accordance with the DUA/role-based access controls associated with this user, this user's role, and the particular dataset. Once analytic workspace dataset publication is complete, the analytic workspace engine 230 sends a notification to the user that the dataset is available in the analytic workspace, and a clock is triggered for environment duration tracking. The notifications can take various forms including electronic mail notifications, slack messages, pop-up windows, and the like.

The OaaS platform 200 further includes a security relationship management engine 240 that includes a user application programming interface (API) 242, a data usage agreement (DUA) API 244, and dataset API 246. The security relationship management engine 240 provides computing logic and resources for maintaining the security of the datasets with regard to the particular users accessing those datasets, in accordance with DUAs. The security relationship management engine 240 enforces role-based access control policies, such as via interaction with the role-based access controls 216, and manages the mapping between user profiles, dataset classifications, and compute environment requirements. The security relationship management engine 240 evaluates data access requests by comparing the user's profile, the requested dataset's PHI/PII classification, and the compute environment's security and compliance features against pre-defined access control policies and edge cases. The security relationship management engine 240 automatically approves, denies, or escalates requests for human review based on these policies and the accumulated knowledge from previous access decisions. The security relationship management engine 240 provides a component in implementing the decision-making process which automates the evaluation of data access requests based on the defined policies and edge cases, ensuring consistent and efficient decision-making.

The OaaS platform 200 further includes a security relationship management engine 240 that includes a user application programming interface (API) 242, a data usage agreement (DUA) API 244, and dataset API 246. The security relationship management engine 240 provides computing logic and resources for maintaining the security of the datasets with regard to the particular users accessing those datasets, in accordance with DUAs and attribute-based access control policies. The security relationship management engine 240 enforces role-based access control policies and attribute-based access control policies, such as via interaction with the role-based access controls 216, and manages the mapping between user profiles, dataset classifications, and compute environment requirements. The security relationship management engine 240 evaluates data access requests by comparing the user's profile, user attributes, the requested dataset's PHI/PII classification, dataset attributes, and the compute environment's security and compliance features against pre-defined access control policies and edge cases. The security relationship management engine 240 automatically approves, denies, or escalates requests for human review based on these policies and the accumulated knowledge from previous access decisions. The security relationship management engine 240 provides a component in implementing the decision-making process which automates the evaluation of data access requests based on the defined policies, attribute-based access control rules, and edge cases, ensuring consistent and efficient decision-making.

In addition to the specific components above, the OaaS platform 200 further includes other backend services and software, data, and/or hardware resources 250 that are required to support the storage, compute, scheduling, environmental management, versioning control for associated datasets and models, security monitoring and tracking, and other operations of the OaaS platform 200. In some illustrative embodiments, these backed services and resources are provided by an established cloud infrastructure.

Thus, in one or more illustrative embodiments, by integrating the above components of the OaaS platform 200, the OaaS platform 200 leverages the defined axes of datasets, user profiles, and compute environments to streamline the review and approval process for healthcare research projects. The OaaS platform's ability to automatically classify datasets, evaluate user qualifications, and enforce access control policies based on pre-defined edge cases and accumulated knowledge significantly reduces the administrative burden on review committees while maintaining the necessary safeguards for protecting sensitive data. As the OaaS platform 200 processes more access requests and edge cases over time, it continuously refines its decision-making capabilities, leading to increased automation and efficiency in the approval process.

Thus, in the context of a healthcare based research domain, for example, as shown in FIG. 2, the OaaS platform 200 provides a data vault 210 that is a flexible ingestion and integration layer of the OaaS platform 200 which understands healthcare data domains and provides integration points for data quality activities across a multi-model data ingest spectrum. The data vault 210 may provide a secure petabyte-scale persistence layer with adaptive query mechanisms that can provide bulk and transaction level data exploration, query, and extraction/provisioning capabilities.

Thus, the OaaS platform 200 of the illustrate embodiments provides several advantages. By acquiring/storing/enabling an association-diverse multi-modal dataset, the OaaS platform 200 allows for a wide range of data types to be utilized for research purposes within the data vault. The classification of inbound source datasets into a data catalog 214 supports different data source infrastructure patterns, providing flexibility in managing and organizing data. The dataset intake mechanisms, e.g., researcher intake form and processing, as well as the data catalog dataset access mechanisms, e.g., research data catalog access request form and processing, streamline the process of loading relevant datasets and models to the data vault 210 and enable users, e.g., researchers, to easily request access to the data vault 210. These features enhance the efficiency, accessibility, and organization of data within the OaaS platform 200, ultimately improving the analytic process performed via dynamically generated analytic workspaces, e.g., research processes on various datasets.

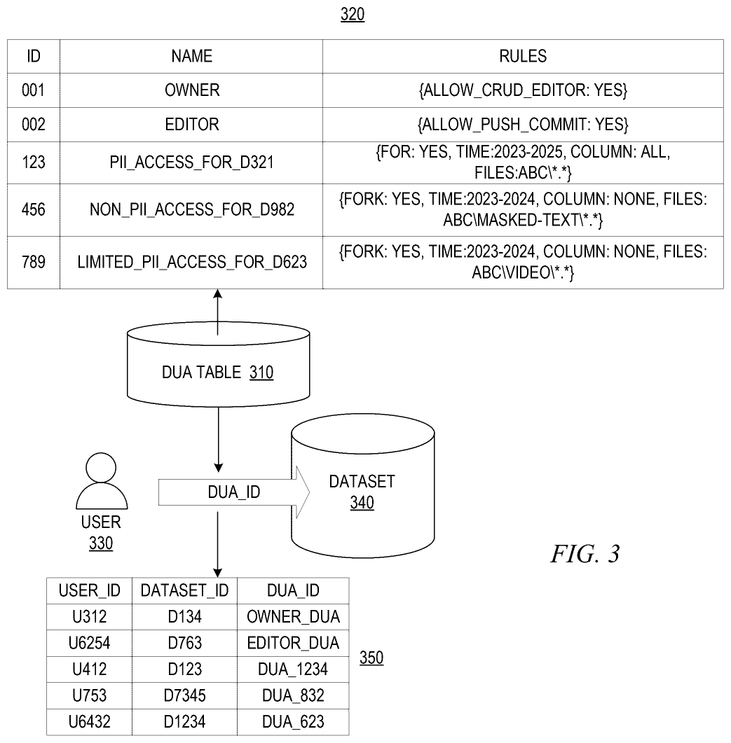

As mentioned previously, the provisioning or publishing of datasets to the analytic workspaces may be dependent upon established data usage agreements (DUAs) and role-based access control (RBAC) mechanisms. FIG. 3 is an example diagram illustrating the relationships between Data Usage Agreements (DUAs), users, and datasets within the Obfuscation-as-a-Service (OaaS) platform 200, in accordance with one illustrative embodiment. The diagram consists of three main components: the DUA table 310, the user table 330, and the dataset table 340, along with a relationship table 350 that connects them. FIG. 3 is only an example and is not intended to limit the illustrative embodiments. Thus, many modifications to the particular DUA table 310, user table 330, dataset table 340, and relationship table 350 contents may be made without departing from the spirit and scope of the present invention.

The DUA table 310 contains a list of predefined DUAs, each with a unique identifier (DUA_id), a name, and a set of rules governing the access and usage of datasets. For example, the “owner” DUA (DUA_id: 001) has the rule “allow_CRUD_editor: yes”, indicating that users with this DUA have full Create, Read, Update, and Delete (CRUD) privileges for the associated datasets. Another example is the “Non_PII_access_for_d982” DUA (DUA_id: 456), which has rules specifying that users with this DUA can fork the dataset, have access to it from 2023 to 2029, but cannot access any columns containing Personally Identifiable Information (PII), but can access the files under this path: ABC\masked-text\*

The user table 330 and the dataset table 340 contain unique identifiers for users (user_id) and datasets (dataset_id), respectively. These tables may include additional attributes and metadata related to users and datasets, which are not shown in the diagram for simplicity.

The relationship table 350 is a mapping table that connects users, datasets, and DUAs. Each row in this table represents a unique combination of a user, a dataset, and a DUA, specifying the access privileges and restrictions for that particular user-dataset pair. For example, the first row indicates that User 1 has access to Dataset A under the terms of DUA 001 (the “owner” DUA), while the second row indicates that User 2 has access to Dataset B under the terms of DUA 789.

The diagram also illustrates that DUAs are not necessarily unique to each user-dataset pair, but rather can be reused across multiple pairs. This allows for efficient management of access controls and helps maintain consistency in the application of data usage policies across the platform.

In the context of the OaaS platform 200, the DUA table 310 and the relationship table 350 are used by the role based access control system 216 to automatically evaluate data access requests and determine the appropriate level of access for each user-dataset pair. When a user submits a data access request, the role based access control system looks up the corresponding DUA in the relationship table 350 and applies the associated rules and restrictions to the provisioned dataset in the analytic workspace.

Thus, in one or more illustrative embodiments, as shown in relationship table 350, pairings of user_id and dataset_id, i.e., pairing of a user with a dataset, has an associated DUA identifier (DUA_id) specifying the DUA applicable to the user (user_id) accesses the dataset (dataset_id) via a dynamically generated analytic workspace. These DUA identifiers are correlated with the rules for that DUA as specified in DUA table 310 and the rules are applied when approving and publishing datasets to the user's analytic workspace, such as in response to a user submitting a request to perform analytic operations on the dataset using a dynamically generated analytic workspace. Thus, the particular rules and corresponding obfuscations of datasets that must be applied when provisioning the data to an analytic workspace may be automatically determined and customized to the particular user and the particular dataset.

In some illustrative embodiments, there are three primary types of DUAs that are utilized. A first type of DUA is referred to as “owner” or “admin” and this DUA may be inherited from the system/platform owner_DUA upon dataset creation. The default owner_DUA can add/remove other users that can access the dataset and change permissions and DUAs associated with other users and the dataset. The owner_DUA allows all editor privileges, e.g., CRUD privileges.

A second type of DUA is referred to as the “editor” DUA and may also be inherited from system/platform default editor_DUA upon dataset creation. The default editor_DUA can change the content of a dataset and push commits back to the dataset.

A third type of DUA is referred to as a “user” DUA. This is a special DUA defined during the data request process and defines whether the user can have access to certain PII/PHI, the length of time the user can access the data with the appropriate obfuscations of PII/PHI, and other access control specifications. This third type of DUA is customizable with regard to the rules so that new types of DUAs may be generated for different types of users and datasets. This customization may generate a new DUA_type entry in the DUA table 310. The DUA_type_id will be put into the relationship table 350 row accordingly.

It should be appreciated that there may be instances where a user/dataset pairing does not have a specified DUA associated with it. Thus, if there is no entry in the DUA table 310 for the particular user_id/dataset_id, then the user is presumed to have a default “preview” relationship with the dataset. Hence, for users that have this “preview” DUA relationship, an entry need not be included in the relationship table 350. This allows for the saving of space in the DUA table 310 by not storing exponentially increasing amounts of preview pairings between most users and datasets. The preview DUA is a view defined by the dataset owner during data intake operations and curation processes. The preview DUA is stored as a child object in the dataset and is used to drive the rendering of the data in the analytic workspace.

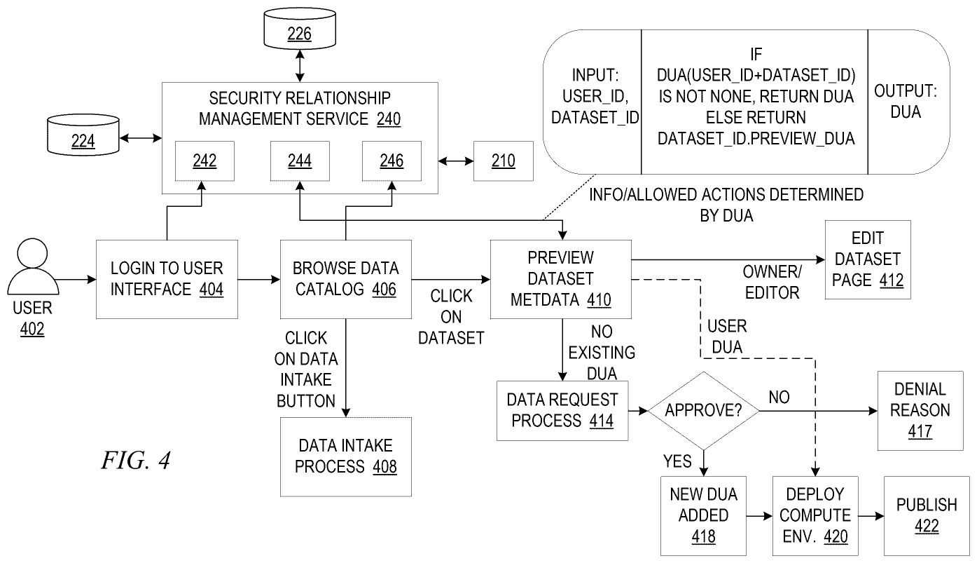

FIG. 4 is an example diagram illustrating an example process for processing intake forms and/or requesting access to datasets in accordance with one illustrative embodiment. The process outlined in FIG. 4 involves the operations of the OaaS platform 200 including the data vault 210 and data catalog 214 with role-based access controls 216, workflow orchestrator 220, user profile manager 224, DUA library 26, analytic workspace engine 230, security relationship management engine 240 with the corresponding APIs 242-246, etc., to facilitate the functionality shown in FIG. 4.

As shown in FIG. 4, a user 402 may login 404 to the OaaS platform 200 in order to access a landing webpage of the OaaS platform 200. The security relationship management service 240 may operate on the login credentials to perform authentication of the user via the user API 242 and then perform a lookup of the user's DUAs via the DUA API 244. The user may browse the datasets of the data vault 210 via a browse dataset webpage 406. The browse dataset webpage 406 may access the dataset API 246 to perform the browsing, applying filter rules to change the list of datasets being displayed. For example, the filter rules may specify a particular location (dataset sovereignty), dataset tags (e.g., disease, data type (x-ray, etc.), hospital information, or the like, for filtering the datasets and displaying the datasets meeting the filter rule criteria.

Having been presented with a dataset listing, potentially filtered according to filter rules, via the browse dataset webpage 406, the user may select a dataset intake user interface element, e.g., clicking on a provided virtual button or the like, to initiate an intake of a new dataset into the data vault 210. As a result, the data intake process 408, described hereafter, may be initiated. Alternatively, the user may select a dataset from the listing, e.g., clicking on a specific dataset entry in the listing, in order to view more details regarding that dataset via a preview dataset webpage 410 that presents preview dataset metadata.

The presentation of dataset metadata details for a selected dataset, via the detailed dataset webpage 410, is governed by the applicable DUAs for the pairing of the user 402 and the dataset as determined by the DUA API 244 of the security relationship management engine 240. The actions that the user 402 can take with regard to the dataset may also be enabled or disabled according to the DUA. The DUAs may be associated with different roles and thus, may operate to enforce a role-based access control (RBAC) by enabling/disabling user 402 abilities for interacting with (CRUD operations) or viewing the dataset. For example, if the DUA associated with the user 402 and the selected dataset, such as specified in the relationship table data structure 350 of FIG. 3, specifies an owner or editor type DUA, then the user 402 may be presented with a corresponding webpage with tools enabled for editing the dataset 412.

If there is no DUA associated with the user 402 and selected dataset, a data request process may be initiated 414 whereby a request is sent to an administrator or other authorized personnel to provide authorization for the user 402 to access the detailed view of the selected dataset and specify other permissions for that user 402 with regard to the selected dataset. For example, this may involve generating a new DUA that is added as an entry in the DUA table data structure 310/320, or associating an existing DUA, e.g., from the DUA library 226 as indicated by an entry in the DUA table data structure 310, with the particular pairing of the user 402 with the selected dataset. In either case, a new instance of a DUA may be stored in the DUA library 226 and represented in the relationship table 350 of FIG. 3 for use in performing lookup of DUAs associated with pairings of this user 402 with the selected dataset in future operations.

As shown in FIG. 4, the data request process 414 involves determining whether the administrator or other authorized personnel approve or disapprove 416 the user 402 accessing the selected dataset. If the access is denied, a corresponding notification may be transmitted to the user 402 via their computing device informing them of the denial and the reasoning for the denial 417 and the operation terminates. If the access by the user 402 to the selected dataset is approved, a new DUA is added 418 to the DUA library 226, a corresponding entries in the DUA table 310/320 and/or the DUA relationship table 350 are added for the particular pairing of the user 402 and the selected dataset. A dynamically generated analytic workspace is then generated 420 through which the particular research compute environment is displayed for the user 402 to perform work with regard to the selected dataset. As also shown in FIG. 4, if the DUA applicable to the particular combination of the user 402 and the selected dataset is a “user” DUA, i.e., the special DUA that is customizable for different users, then the operation jumps to the dynamic generation of the analytic workspace 420.

The selected dataset is then provisioned or published to the dynamically generated analytic workspace 422. This provisioning or publishing of the selected dataset to the analytic workspace associated with the user 402 is in conformance with the obfuscation requirements, also referred to as mask requirements, associated with the role-based access controls and DUA. That is, depending on the particular role of the user 402 and the obfuscation (masking) rules associated with the role of the user 402, the dataset presentation and/or available operations for the user provided via the analytic workspace, may be adjusted to protect sensitive data, e.g., PII/PHI. Thus, from some roles, users will be able to view the PII/PHI without obfuscation, for other roles the users will be able to view redacted or modified forms of PII/PHI the datasets, e.g., only certain columns/rows with other columns/rows modified or deleted from the presentation, and still other users will not be able to view PII/PHI at all in the presentation of the datasets. Moreover, similar to the DUAs, these role based access controls may enable/disable available operations that the user 402 can take with regard to PII/PHI.

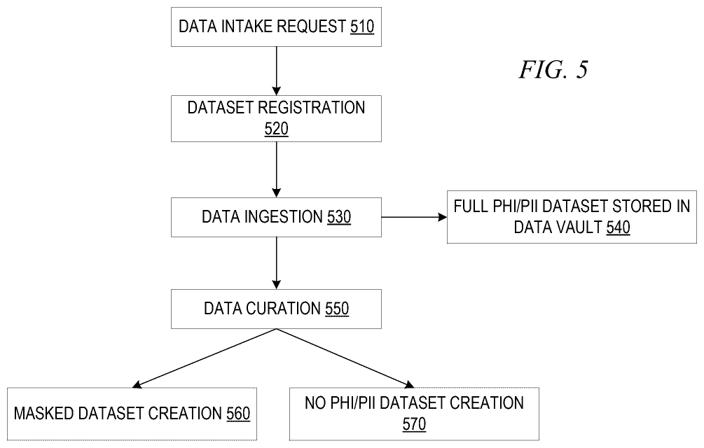

FIGS. 5-7 present flow diagrams outlining example operations of elements of the present invention with regard to one or more illustrative embodiments. It should be appreciated that the operations outlined in FIGS. 5-7 are specifically performed automatically by an improved computer tool of the illustrative embodiments and are not intended to be, and cannot practically be, performed by human beings either as mental processes or by organizing human activity. To the contrary, while human beings may, in some cases, initiate the performance of certain ones of the operations set forth in FIGS. 5-7, and may, in some cases, interact with the computing elements, such as by providing input, and make use of the results generated as a consequence of the operations set forth in FIGS. 5-7, e.g., viewing datasets via user interfaces and the like, the operations in FIGS. 5-7 themselves that operate on such inputs and automatically and dynamically generate the results, are specifically performed by the improved computing tool in an automated manner.

That is the OaaS platform 200 is itself a non-generic computing tool specifically configured and arranged to implement the computing elements shown in FIG. 2 and provide the functionalities of FIGS. 5-7 to facilitate Obfuscation-as-a-Service and dynamic/automated generation of analytic workspaces which are automatically provisioned with tooling and datasets, in accordance with appropriate DUA and role-based access controls dictating how the analytic workspace environment is represented to the user, i.e., the level and how obfuscation or masking of portions of the dataset are to be performed when provisioning the analytic workspace with particular datasets, and which tools are enabled/disabled with regard to a particular pairing of user and dataset within that analytic workspace.

FIG. 5 is an example diagram illustrating an example process for a data intake operation in accordance with one illustrative embodiment. This process is followed, for example, when a user wishes to add a dataset to the data vault 210 in FIG. 2. The process involves the OaaS platform 200, data vault 210, data cataloging engine 212, and data catalog 214 with associated access controls 216, which each perform their operations as previously described above to facilitate the functionality shown in FIG. 5.

As shown in FIG. 5, the user 402, via their user workstation, may interact with the OaaS platform 200 frontend components, i.e., components that provide user interfaces and the like and which interact with the user 402, to fill out a data intake form 510 in order to initiate a data intake operation. The data intake form, which is an electronic form that may be presented to the user 402 via one or more user interfaces, may take many different forms depending on the desired implementation. For example, in some illustrative embodiments, the data intake form 510 may require that the user merely specify the user's identity (user_id), an identifier of the dataset that is to be added to the data vault 210 (a dataset_id may be automatically associated with the dataset when it is created in the data vault 210), and information about the DUAs and/or role-based access controls that are to be associated with the particular dataset. In other implementations, the data intake form may comprise additional elements for inputting more detailed information about the user, dataset, and DUAs/role-based access controls. It should be appreciated that the information provided in the user populated data intake form 510 may be used in conjunction with automatically extracted information from an analysis of the dataset itself and/or metadata associated with the dataset, so as to gather the necessary information for data cataloging and association of DUAs and role-based access controls with the dataset and/or user.

As shown in FIG. 5, following the submission of the filled out data intake form 510, backend components, such as data intake engine 218, operate to perform operations for creating the dataset in the data vault 210 and associating DUAs with the dataset, which is referred to as dataset registration 520. These backend components, such as data intake engine 218, DUA API 244, dataset API 246, and the like, perform the automated mechanisms for processing users inputs, generating results, and providing those results to the frontend for presentation to the user via their user workstation.

For example, based on the filled out data intake form 510, and in some cases information automatically extracted by analysis of the dataset specified by the user, as part of this dataset registration 520, a new dataset entry is created in the dataset table data structure of the data vault 210 using the dataset API 246, and the corresponding dataset_id is returned 504 to the data intake engine 218. A new DUA entry may be created for the particular pairing of the dataset_id and user_id of the user which specifies the user to be the owner of the dataset. This new DUA entry may be created, via the DUA API 244, in the relationship table data structure 350, for example, automatically as the user submitting the data intake form for adding the dataset to the data vault 210 is presumed to be the dataset owner.

A data ingestion operation 530 is performed for ingesting the dataset into the data vault 210. As part of this data ingestion operation 530, an empty dataset repository, e.g., gitlab repo, is created and the user is given access to the dataset repository. The information for accessing this repository may be stored in the dataset table data structure of the data vault 210, e.g., the gitlab repo uniform resource locator (URL) may be stored in the dataset table data structure of the data vault 210. For example, the dataset API 246 may operate to interface with GitLab™ resources to operate GitLab™ to create the repository and provide the URL for inclusion in the dataset table. In some embodiments, other git operations described herein, may be performed using git or gitlab user interfaces.

Having created a new DUA entry and a new dataset repository for holding the dataset, the dataset is pushed to the newly created empty dataset repository. The dataset stored in the new dataset repository in the data vault 210 may be a full PHI/PII dataset in which there is no obfuscation/masking of the PHI/PII present in the dataset 540. Dataset intake completion may then be confirmed, such as via the gitlab user interface (UI) or the like. Thereafter, data curation 550 operations may be performed to generate various versions of the full PHI/PII dataset which are modified through obfuscation/masking to provide different levels of security with regard to PHI/PII that may be present in the dataset.

It should be appreciated that the dataset owner may skip the data curation step and perform data curation at a later time; otherwise, the functionality proceeds to the data curation process 550. This data curation process 550 involves the data obfuscation engine 228 parsing the dataset to identify instances of PHI/PII in the dataset and marking/labeling these instances. Thereafter, various obfuscation or masked versions of the dataset are generated for different levels of security. For example, for a first level of security, certain types of PHI/PII instances may be obfuscated or masked, whereas for a second level of security, all PHI/PII may be obfuscated or masked. The obfuscation or masking itself may take various forms, such as removal, replacement with non-PHI/PII content, or the like. Thus, through the data curation process, various versions 560, 570 of the dataset 540 may be generated and added to the data vault 210, and the corresponding elements of the dataset dictionary table populated with the corresponding information, i.e., the PII/PHI free commit for the obfuscated/masked version, the path to the obfuscated/masked version, and the name of the process used to generate the obfuscated/masked version.

After data curation is performed, or is skipped by the data owner, an editable data card view/draft is displayed and the owner (or editor role users) are allowed to input more information that was not captured in the data intake form or through automated extraction processes. For example, a detailed description of the dataset, import and curated preview view from the analytic workspace, or the like. The data card is a summary description of the dataset and the metadata associated with the dataset. The data card may be published to the data catalog 214, for example.

In some illustrative embodiments, as part of the dataset curation process, a user may interact with the dataset API 246 of the security relationship management engine 240 to create and import a data dictionary table for a dataset into the OaaS platform 200, and specifically the data vault 210. In so doing, the user interfaces with the security relationship management engine 240 of the OaaS platform 200, and specifically with the dataset API 246, to create or import a data dictionary table for the dataset into the data vault 210. The data dictionary table may be, for example, a child table under the dataset object in the data vault 210. This process operates on a single dataset and outputs a new commit to itself. The data dictionary table may take many different forms depending on the desired implementation. For example, the data dictionary table may include columns for the name of the data files in the dataset, description of the data files, file type, raw commit values, raw path, PII/PHI free commit value, PII/PHI free path, and PII masking process used to obfuscate or mask the PII/PHI in the PII/PHI free versions of the data.

The user may then define the obfuscation/masking requirements for the dataset to generate an obfuscated/masked version of the data files in the dataset for one or more levels of obfuscation/masking. The obfuscated/masked version of the dataset or data file may be then exported back to the data vault 210 and a new branch and commits are created, where a “branch” is a new version of a main repository, also referred to as a primary or raw dataset. The information regarding the obfuscated/masked version of the data files in the dataset are stored in the dataset dictionary table in the appropriate fields, e.g., PII/PHI-free commit, PII/PHI-free path, etc. so that the smart filtering mechanisms of the illustrative embodiments (see FIG. 1B) may utilize this information when applying DUAs and role-based access controls to requests for access to datasets and identify where the obfuscated/masked versions of the data files of the datasets may be retrieved from in the data vault 210. An identifier of the particular obfuscation/masking process used to generate the obfuscated/masked version of the data files in the dataset may be stored in the dataset dictionary table as the PII/PHI obfuscation/masking process, so that this same dataset obfuscation/masking process can be reused in the future should there be any updates, e.g., manual updates or streaming updates, and the obfuscation/masking needs to be performed on the updated data files of the dataset.

The owner/editor of the dataset can edit the data card for the dataset to annotate that the obfuscated/masked version of the dataset exists and can create a preview in the data card to show this obfuscated/masked version. The data card may comprise information about the particular dataset, such as a description, location, compliance information, sources of the data for the dataset, as well as a listing of the available versions of the dataset. The versions of the dataset may correspond to differing levels of obfuscation/masking, e.g., raw data which contains PII/PHI, PII/PHI masked views of the dataset, and PII/PHI removed views of the dataset. It should be appreciated that the PII/PHI masked views represent the dataset with particular portions of the dataset masked, e.g., the portions are replaced with alternative portions that do not divulge sensitive or private data, e.g., PII/PHI. The PII/PHI removed views refers to a view of the dataset where the portions are completely removed and not replaced, e.g., columns of a table storing PII/PHI are completely removed from the view. The data card may comprise user selectable interface items, such as the “Request Access” buttons through which a user may request access to the corresponding view of the dataset in their dynamically generated analytic workspace. The buttons contain the commit_hash such that a user clicking on the button will cause a data request form to be presented which points to the particular version/commit. After approval, either automatically or through manual approvals if needed, a copy of the dataset's data files of the particular version will be provided or published to the analytic workspace, e.g., a fork is generated in the analytic workspace.

FIGS. 6A-6D set forth an example flowchart outlining a data request decision making process in accordance with one illustrative embodiment. As shown in FIG. 6A, the operation starts with a user submitting a new request for access to a specific dataset (step 602). The OaaS platform, also referred to herein as the “system”, extracts relevant information about the requested dataset, the user's profile, and the proposed compute environment from the data request (step 604). For example, the user profile may include attributes such as the user's organizational role, location, required training/certifications, past project experience, and the like. This user profile data may come from the user API 242 querying the user profile manager 224, for example. The dataset metadata may include the PHI/PII classification, data use restrictions, provenance, and the like, and may be retrieved via the dataset API 246 querying the data catalog 214. The compute environment information may include the security controls, hosting location, compliance certifications, and the like, and may be obtained from the analytic workspace engine 230 and compute environment manager 252.

The system evaluates the dataset's PHI/PII classification and determines the security requirements based on the applicable Data Usage Agreement (DUA) and governing regulations corresponding to the pairing of the user profile and dataset (step 606). The system checks the user's profile for any potential conflicts of interest or red flags that might require additional scrutiny (step 608). The potential conflicts and red flag check may comprises comparing the user's organization (e.g., clinical trial data from a company should not be shared with a competitor's employee) and location (e.g., per GDPR, European Union (EU) PHI cannot be processed outside of the EU) to the dataset's allowed use policy to check for violations. This check may further involve determining if the user has completed the required training for accessing PHI data. This check may also include evaluating past access policy violations associated with the user. The criteria for what constitutes a red flag may be defined in a policy rules engine. The checks may be performed by retrieving the relevant user/dataset attributes and evaluating them against the rules of the policy rules engine.

If no conflicts or red flags are found (step 610: NO), the system proceeds to compare the request with similar approved and denied edge cases (step 612). The system compares the current request with previously reviewed edge cases to determine its position within the decision space (step 612). If the request falls within the safe zone (i.e., closely matches an approved edge case), the system automatically approves the request and assesses if compute environment adjustments are possible to save resources (step 614). If adjustments are possible, the system proposes the changes to the user. If no adjustments are necessary or the user accepts the changes, access is granted (see FIG. 6B). If the request falls below the decline line (i.e., closely matches a denied edge case), the system assesses if adjustments to the researcher's profile, compute environment security level, or PHI/PII obfuscation/masking can be made to meet the dataset's security requirements (step 616). If adjustments are possible and sufficient, the system proposes the changes to the user. If the user accepts, access is granted; otherwise, access is denied, and recommendations are provided. If adjustments are not possible or insufficient, access is denied, and recommendations are provided (see FIG. 6C). If the request falls between the approval and decline zones (i.e., does not closely match any previous edge cases), the system assesses if adjustments can be made to meet the security requirements (step 618). If adjustments are possible and sufficient, the system proposes the changes and escalates the request for human review with suggestions. If adjustments are not possible, insufficient, or unclear, the request is escalated for human review with the available information and suggestions (see FIG. 6D).

If potential conflicts or red flags are identified (step 610: YES), the request is escalated for human review (step 620). For requests that require human review, a designated committee or expert evaluates the request based on the available information, considering the proposed adjustments, and makes a final decision (step 622). For the operation of step 622, information collected in previous operations (e.g., user profile, dataset metadata, access request details, risk factors, etc.) may be presented to an administrator, data governance committee, or other authorized personnel. The human reviewers may evaluate any factors not fully covered by the automated mechanisms and make judgement based on these additional factors and organizational and regulatory guidelines. The decision and rationale generated may be captured and fed back into the mechanisms of the illustrative embodiments as a new “case” to refine future automated decisions, e.g., a new point in the multi-dimensional project space may be defined and used to evaluate future requests. Such operations similarly apply to similar human review operations in steps 668 and 670 hereafter.

If the request is approved (step 624), access is granted, the decision is recorded as a new edge case, and the approved adjustments are implemented (step 628). If the request is denied, access is denied, the decision is recorded as a new edge case, and recommendations are provided to the user (step 626).

As shown in FIG. 6B, as part of the operation of step 614 in FIG. 6A, if the request falls within the safe zone (i.e., closely matches an approved edge case), the system automatically approves the request and assesses if compute environment adjustments are possible to save resources (step 630). If adjustments are possible (step 632: YES), the system proposes the changes to the user (step 634). If no adjustments are necessary or the user accepts the changes (step 636: YES), access is granted (step 638). If no adjustments are possible or the user does not accept the adjustments (step 636: NO), then access is denied and recommendations regarding adjustments may be presented to the user (step 640).

As shown in FIG. 6C, as part of the operation of step 616 in FIG. 6A, if the request falls below the decline line (i.e., closely matches a denied edge case), the system assesses if adjustments to the researcher's profile, compute environment security level, or PHI/PII obfuscation/masking can be made to meet the dataset's security requirements (step 642). If adjustments are possible and sufficient (step 646: YES), the system proposes the changes to the user (step 648). If the user accepts (step 650: YES), access is granted (step 660); otherwise, if adjustments are not possible and sufficient (step 646: NO) or the user does not accept the adjustments (step 650: NO), access is denied, and recommendations are provided to the user (step 662).

As shown in FIG. 6D, as part of the operation of step 618 in FIG. 6A, if the request falls between the approval and decline zones (i.e., does not closely match any previous edge cases), the system assesses if adjustments can be made to meet the security requirements (step 664). If adjustments are possible and sufficient (step 666: YES), the system proposes the changes and escalates the request for human review with suggestions (step 670). If adjustments are not possible, insufficient, or unclear, the request is escalated for human review with the available information and suggestions (step 668). In either case, huma review is performed to generate a decision as to whether to approve or deny the request (step 672). If the request is approved (step 674: YES), then access is granted, the edge case is recorded and the approved adjustments are implemented (step 676). If the request is denied (step 674: NO), then the access is denied, the edge case is recorded, and recommendations are provided to the user (step 678). The operation then terminates.

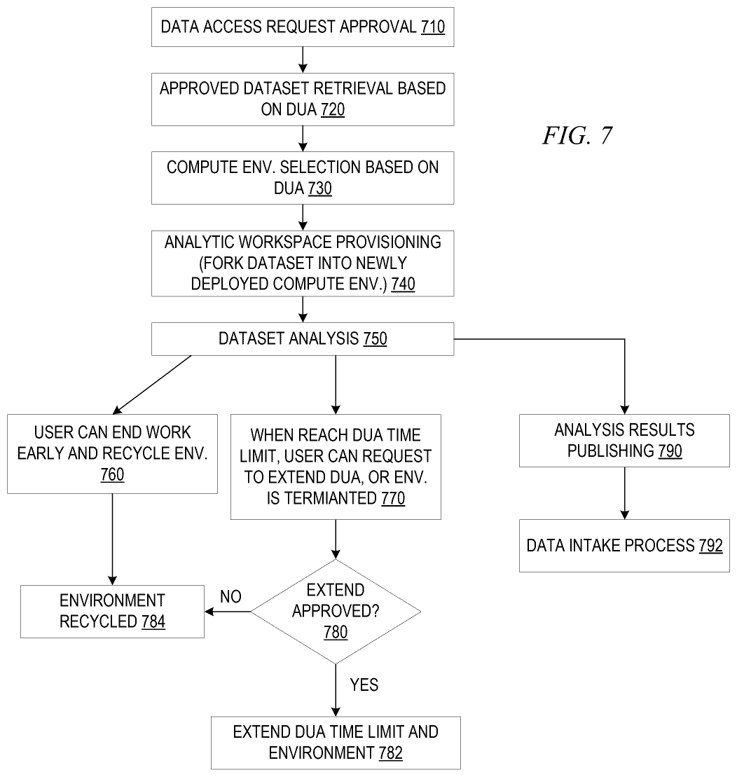

FIG. 7 is an example flowchart outlining an example data provisioning lifecycle process in accordance with one illustrative embodiment. As shown in FIG. 7, the operation starts with a dataset access request having been approved through one of the processes previously discussed above (step 710). The appropriate version of the requested dataset is retrieved from the data vault based on the DUA associated with the pairing of the user and dataset, such that an appropriate level of security and obfuscation/masking is performed on the dataset when provisioning the dataset to the analytic workspace (step 720). The compute environment is determined based on the DUA (step 730). It should be appreciated that with the retrieval of the appropriate dataset version based on the DUA in step 720, the DUA associated with the user/dataset pairing may be used to determine the allowed level of access, e.g., no PHI, limited PHI with obfuscation/masking, full PHI, or the like. The data catalog may then be queried to retrieve the location in the data vault of the corresponding dataset version matching the allowed level of access. If an appropriate version does not already exist, the data obfuscation engine 228 may be invoked to generate the dataset version that is required from the raw dataset (or primary dataset) securely stored in the data vault.

The analytic workspace is provisioned, e.g., the dataset is forked into the newly deployed compute environment (step 740). The compute environment specified in the request may be instantiated by invoking the analytic workspace engine 230 and the compute environment manager 252. The requested dataset is forked as a copy into the data storage volume and mounted to the provisioned workspace for the user to access and perform analytic computation. The access credentials and environment details are securely transmitted to the user.

The user may then perform data analysis operations using the provisioned dataset and the deployed compute environment (step 750). In performing the dataset analysis, at some point the user may end the work early and recycle the compute environment (step 760). In such a case, the environment recycle operations may be performed to recycle the resources and data structures (step 784). The recycling of the resources and data structures may include the data storage volume being destroyed, e.g., with random numbers written into the hard drive to overwrite the dataset information, to prevent unauthorized recovery. The compute environment may be deleted and the reserved compute resources, e.g., CPU, GPU, memory, hard drive, and the like, may be released back to the pool of resources for other project usage. This recycle process may be recorded and attached to the project's life-cycle log for auditing and compliance purposes.

At some point, the user may reach the DUA time limit, where the user may then need to apply to the data owner for an extension of the DUA or the environment may be terminated (step 770). In such a case, if the request for the extension of the DUA is denied (step 780: NO), then the environment may be recycled (step 784). If the request is approved (step 780: YES), then the extended DUA time limit is utilized and the dataset analysis 750 may continue with the extended time period for the environment (step 782). It should be appreciated that the project life-cycle log may be updated with a recorded log indicating the updated time limit and the environment can be used during the extended period.

At some point the user may determined to publish the results of the dataset analysis to the data vault (step 790). As a result, the data intake process previously described above may be initiated for the dataset analysis results (step 792).

It can be seen from the above that the illustrative embodiments provide an improved computing tool and improved computing tool operations for facilitating automated and dynamic generation of analytic workspaces and provisioning of these analytic workspaces with datasets while enforcing DUAs and RBACs associated with pairings of users and datasets. This process is performed in a dynamic and automated manner such that users are not required to engage in time consuming and resource consuming negotiations of the terms under which the user may access the datasets when the user wishes to access those datasets. To the contrary, the illustrative embodiments automatically and dynamically determine the DUAs and RBACs associated with the user-dataset pairing and automatically and dynamically apply those DUAs and RBACs to the presentation and enabling of tools within an analytic workspace in an on-demand manner.

As described above, the illustrative embodiments implement an Obfuscation-as-a-Service (OaaS) platform 200, and as such, may be implemented in a cloud computing environment. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics of cloud computing are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

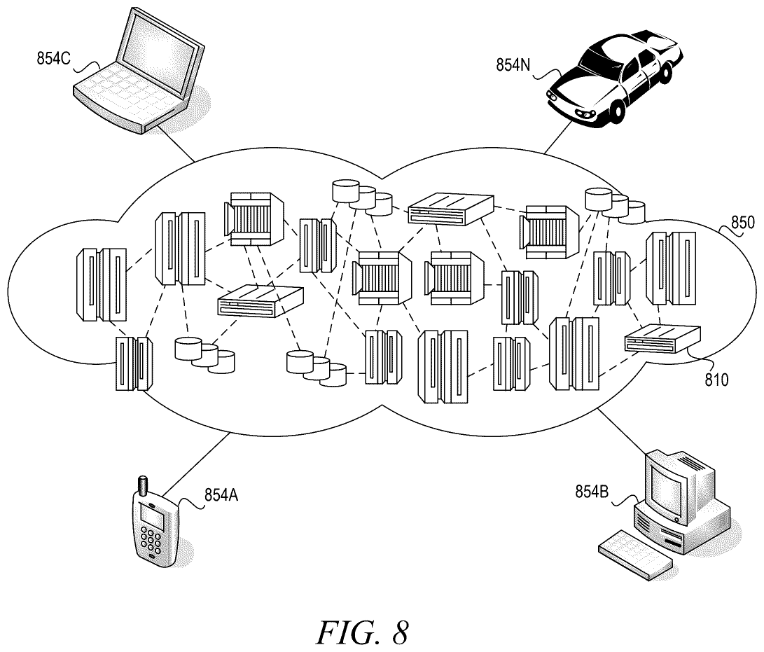

Referring now to FIG. 8, illustrative cloud computing environment 850 is depicted. As shown, cloud computing environment 850 includes one or more cloud computing nodes 810 with which local computing devices used by cloud consumers, such as, for example, personal digital assistant (PDA) or cellular telephone 854A, desktop computer 854B, laptop computer 854C, and/or automobile computer system 854N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 850 to offer infrastructure, platforms and/or software as services for which a cloud consumer does not need to maintain resources on a local computing device. It is understood that the types of computing devices 854A-N shown in FIG. 8 are intended to be illustrative only and that computing nodes 810 and cloud computing environment 850 can communicate with any type of computerized device over any type of network and/or network addressable connection (e.g., using a web browser).

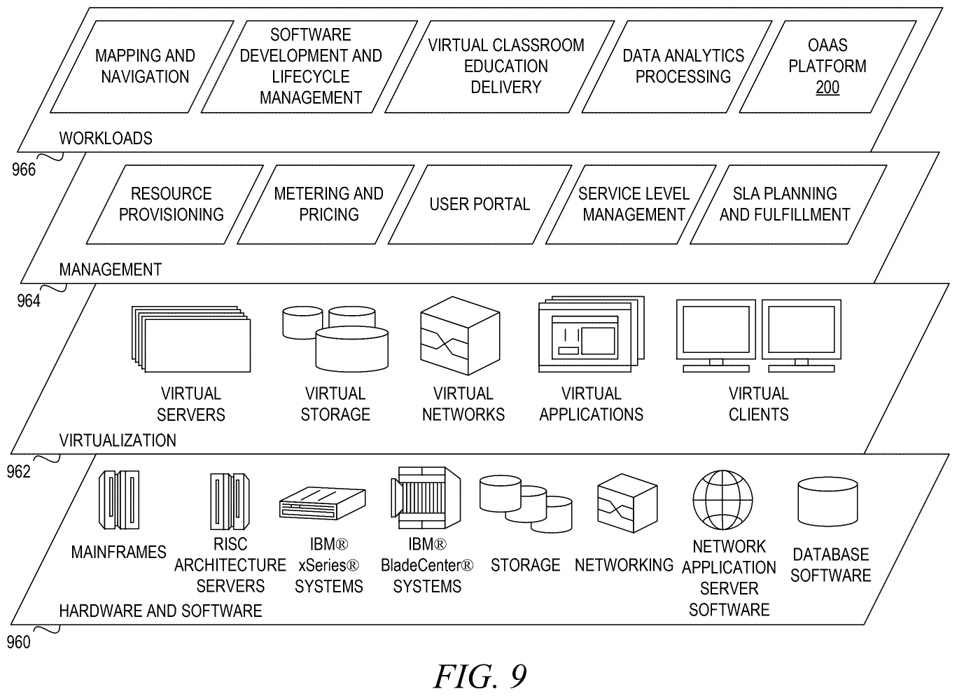

Referring now to FIG. 9, a set of functional abstraction layers provided by cloud computing environment 850 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 960 includes hardware and software components. Examples of hardware components include: mainframes; RISC (Reduced Instruction Set Computer) architecture based servers; servers; blade servers; storage devices; and networks and networking components. In some embodiments, software components include network application server software and database software.

Virtualization layer 962 provides an abstraction layer from which the following examples of virtual entities may be provided: virtual servers; virtual storage; virtual networks, including virtual private networks; virtual applications and operating systems; and virtual clients.

In one example, management layer 964 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 966 provides examples of functionality for which the cloud computing environment may be utilized. Examples of workloads and functions which may be provided from this layer include: mapping and navigation; software development and lifecycle management; virtual classroom education delivery; data analytics processing; transaction processing; and Obfuscation as a Service (OaaS) platform 200. The OaaS platform 200 is provided in accordance with the Platform as a Service aspect of the cloud computing environment as discussed above and provides the above described advantages, in accordance with one or more illustrative embodiments, for automatically and dynamically applying DUAs and role-based access controls to datasets when provisioning analytic workspaces for users, which includes smart filtering and obfuscation/masking of portions of datasets where appropriate based on DUAs and role-based access controls for the particular pairings of users and datasets.

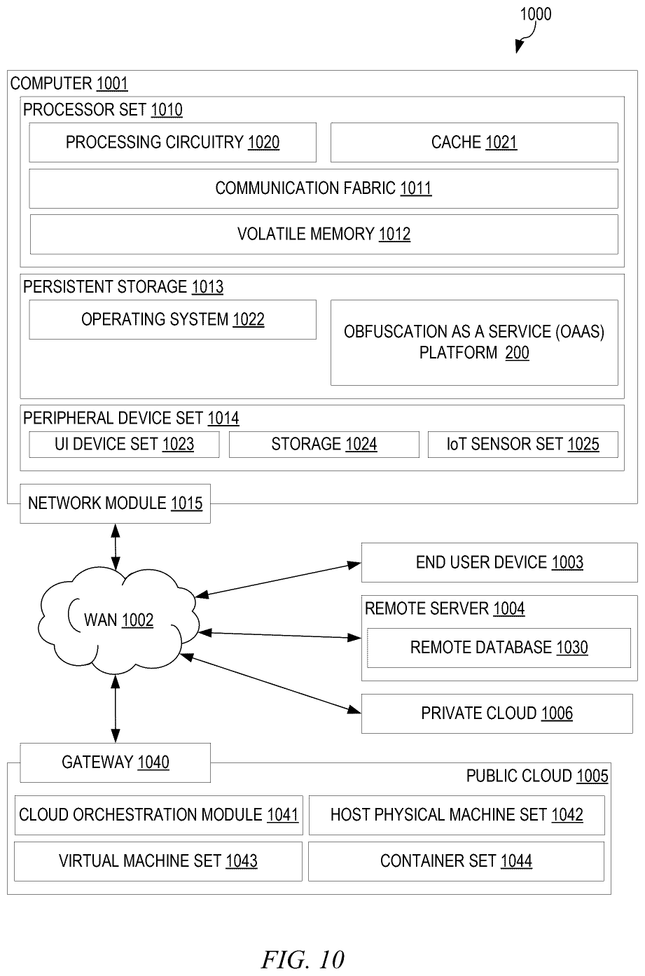

FIG. 10 is an example diagram of a distributed data processing system environment in which aspects of the illustrative embodiments may be implemented and at least some of the computer code involved in performing the inventive methods may be executed. That is, computing environment 1000 contains an example of an environment for the execution of at least some of the computer code involved in performing the inventive methods, such as Obfuscation-as-a-Service (OaaS) platform 200. In addition to OaaS platform 200, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and OaaS platform 200, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

Computer 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

Processor set 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in OaaS platform 200 in persistent storage 1013.

Communication fabric 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

Persistent storage 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in OaaS platform 200 typically includes at least some of the computer code involved in performing the inventive methods.

Peripheral device set 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

Network module 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

Remote server 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

Public cloud 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
storing a plurality of datasets in a data vault for provisioning to dynamically generated workspaces associated with users, wherein the dynamically generated workspaces are computer environments through which the users can perform operations on the one or more datasets;
receiving a request, from a user, for access to a specified dataset;
retrieving a data usage agreement (DUA) corresponding to a pairing of the user with the specified dataset, wherein the DUA specifies a level of obfuscation to be applied to the specified dataset when provisioning a workspace associated with the user, with the specified dataset;
dynamically generating, on-demand, the workspace associated with the user based on the retrieved DUA; and
automatically provisioning, on-demand, the dynamically generated workspace with a version of the specified dataset corresponding to the level of obfuscation specified in the DUA.

2. The computer-implemented method of claim 1, wherein automatically provisioning, on-demand, the dynamically generated workspace comprises selecting a version of the specified dataset that has the level of obfuscation specified in the DUA from a plurality of versions of the specified dataset stored in the data vault.

3. The computer-implemented method of claim 1, wherein the dynamically generated workspace is one of a cloud virtual machine, an integrated development computer environment, or a computer desktop instance.

4. The computer-implemented method of claim 1, further comprising:
automatically determining whether to approve or deny the request based on a generated representation of the request in a multi-dimensional project space representing at least a pairing of the user and the specified dataset, and comparing the representation of the request to representations of previous requests.

5. The computer-implemented method of claim 4, wherein the multi-dimensional project space is a three dimensional project space having a user profile dimension, a dataset dimension, and a compute environment dimension, wherein the user profile dimension comprises one or more characteristics of the user from which the request is received, the dataset dimension comprises one or more characteristics representing at least a security level required for accessing a corresponding dataset, and the compute environment dimension comprises one or more characteristics representing a level of security afforded by a corresponding compute environment.

6. The computer-implemented method of claim 4, wherein automatically determining whether to approve or deny the request comprises:
comparing a first point in the multi-dimensional project space corresponding to the request, to a plurality of second points corresponding to other requests with which an approval or denial has been previously associated; and
automatically determining whether to approve or deny the request based on results of the comparison, wherein the dynamically generating and automatically provisioning operations are performed in response to approval of the request.

7. The computer-implemented method of claim 6, wherein comparing the first point to the plurality of second points comprises determining whether the first point falls within a safe range of the plurality of second points, falls within a decline range of the plurality of second points, or falls within a boundary edge case range of the plurality of second points.

8. The computer-implemented method of claim 7, wherein in response to the first point falling within the safe range, the request is automatically approved, wherein in response to the first point falling within the decline range, the response is automatically denied, and wherein in response to the first point falling within a boundary edge case range, the request is escalated for human review and approval.

9. The computer-implemented method of claim 7, wherein dynamically generating, on-demand, the workspace associated with the user based on the retrieved DUA comprises automatically adjusting a security level of the compute environment of the workspace to match a required security level for the DUA.

10. The computer-implemented method of claim 1, wherein the plurality of versions of the specified dataset comprise a first version of the specified dataset in which all personal health information or personally identifiable information is obfuscated, a second version of the specified dataset in which some, but not all, personal health information or personally identifiable information is obfuscated, and a third version of the specified dataset in which none of the personal health information or personally identifiable information is obfuscated.

11. A computer program product comprising a computer readable storage medium having a computer readable program stored therein, wherein the computer readable program, when executed on a computing device, causes the computing device to:
store a plurality of datasets in a data vault for provisioning to dynamically generated workspaces associated with users, wherein the dynamically generated workspaces are computer environments through which the users can perform operations on the one or more datasets;
receive a request, from a user, for access to a specified dataset;
retrieve a data usage agreement (DUA) corresponding to a pairing of the user with the specified dataset, wherein the DUA specifies a level of obfuscation to be applied to the specified dataset when provisioning a workspace associated with the user, with the specified dataset;
dynamically generate, on-demand, the workspace associated with the user based on the retrieved DUA; and
automatically provision, on-demand, the dynamically generated workspace with a version of the specified dataset corresponding to the level of obfuscation specified in the DUA.

12. The computer program product of claim 11, wherein automatically provisioning, on-demand, the dynamically generated workspace comprises selecting a version of the specified dataset that has the level of obfuscation specified in the DUA from a plurality of versions of the specified dataset stored in the data vault.

13. The computer program product of claim 11, wherein the dynamically generated workspace is one of a cloud virtual machine, an integrated development computer environment, or a computer desktop instance.

14. The computer program product of claim 11, wherein the computer program product further causes the computing device to:
automatically determine whether to approve or deny the request based on a generated representation of the request in a multi-dimensional project space representing at least a pairing of the user and the specified dataset, and comparing the representation of the request to representations of previous requests.

15. The computer program product of claim 14, wherein the multi-dimensional project space is a three dimensional project space having a user profile dimension, a dataset dimension, and a compute environment dimension, wherein the user profile dimension comprises one or more characteristics of the user from which the request is received, the dataset dimension comprises one or more characteristics representing at least a security level required for accessing a corresponding dataset, and the compute environment dimension comprises one or more characteristics representing a level of security afforded by a corresponding compute environment.

16. The computer program product of claim 14, wherein automatically determining whether to approve or deny the request comprises:
comparing a first point in the multi-dimensional project space corresponding to the request, to a plurality of second points corresponding to other requests with which an approval or denial has been previously associated; and
automatically determining whether to approve or deny the request based on results of the comparison, wherein the dynamically generating and automatically provisioning operations are performed in response to approval of the request.

17. The computer program product of claim 16, wherein comparing the first point to the plurality of second points comprises determining whether the first point falls within a safe range of the plurality of second points, falls within a decline range of the plurality of second points, or falls within a boundary edge case range of the plurality of second points.

18. The computer program product of claim 17, wherein in response to the first point falling within the safe range, the request is automatically approved, wherein in response to the first point falling within the decline range, the response is automatically denied, and wherein in response to the first point falling within a boundary edge case range, the request is escalated for human review and approval.

19. The computer program product of claim 17, wherein dynamically generating, on-demand, the workspace associated with the user based on the retrieved DUA comprises automatically adjusting a security level of the compute environment of the workspace to match a required security level for the DUA.

20. An apparatus comprising:
at least one processor; and
at least one memory coupled to the at least one processor, wherein the at least one memory comprises instructions which, when executed by the at least one processor, cause the at least one processor to:
store a plurality of datasets in a data vault for provisioning to dynamically generated workspaces associated with users, wherein the dynamically generated workspaces are computer environments through which the users can perform operations on the one or more datasets;
receive a request, from a user, for access to a specified dataset;
retrieve a data usage agreement (DUA) corresponding to a pairing of the user with the specified dataset, wherein the DUA specifies a level of obfuscation to be applied to the specified dataset when provisioning a workspace associated with the user, with the specified dataset;
dynamically generate, on-demand, the workspace associated with the user based on the retrieved DUA; and
automatically provision, on-demand, the dynamically generated workspace with a version of the specified dataset corresponding to the level of obfuscation specified in the DUA.
